(19) United States
(12) Patent Application Publication
(10) Pub. No.: US 2010/0069534 A1
(43) Pub. Date: Mar. 18, 2010

(54) Stable Soy/Urea Adhesives and Methods of Making Same

(76) Inventors: James M. Wescott, Waunakee, WI (US); Michael J. Birkeland, Edgerton, WI (US)

Correspondence Address: Joanne Mary Fobare Rossi;Hercules Incorporated, Hercules Plaza, 1313 North Market Street, Wilmington, DE, 19894-0001, US

(21) Appl. No.: 12/507,247

(22) Filed: Jul. 22, 2009

Related U.S. Application Data
(63) Continuation-in-part of application No. 11/779,558, filed on Jul. 18, 2007, now abandoned.
(60) Provisional application No. 60/831,650, filed on Jul. 18, 2006.
(60) Provisional application No. 60/835,042, filed on Aug. 2, 2006.

(51) Int. Cl. C09J 189/00

(52) U.S. Cl. 524/25; 106/155.21; 524/17; 106/145.4; 106/150.2

(57) ABSTRACT

The present invention provides an improved method of producing a stable heat denatured soy/urea adhesive having improved wet and dry strengths, with more efficient production and lower production costs. The method comprises combining urea with soy flour that has been heated until denatured and substantially free from urease activity. The soy flour is preferably heated to a temperature of at least 81° C. up to 100° C. for at least 15 to 500 minutes. Optionally, the method may also include adding a crosslinking agent, diluent or both to the soy flour/urea adhesive and/or adding an emulsified or dispersed polymer. Adhesives and dispersions prepared according to the methods of this invention offer increased stability and strength properties.

### CROSS-REFERENCE TO RELATED APPLICATIONS

This application is a continuation-in-part of U.S. application Ser. No. 11/779,558, filed Jul. 18, 2007, which claims priority to U.S. Provisional Application No. 60/831,650, filed Jul. 18, 2006 and U.S. Provisional Application No. 60/835,042, filed Aug. 2, 2006, all of which are hereby incorporated by reference herein for all purposes.

### FIELD OF THE INVENTION

The invention relates generally to a method of producing stable soy/urea adhesives and stable soy/urea adhesives with dispersed or emulsified polymers from soy flour that has been denatured and is substantially free of urease activity.

### BACKGROUND OF THE INVENTION

Adhesives derived from protein-containing soy flour first came into general use during the 1920's (see, e.g., U.S. Pat. Nos. 1,813,387, 1,724,695 and 1,994,050). Soy flour suitable for use in adhesives was, and still is, obtained by removing some or most of the oil from the soybean, yielding a residual soy meal that was subsequently ground into extremely fine soy flour. Typically, hexane is used to extract the majority of the non-polar oils from the crushed soybeans, although extrusion/extraction methods are also suitable means of oil removal.

The resulting soy flour was then denatured (i.e., the secondary, tertiary and/or quaternary structures of the proteins were altered to expose additional polar functional groups capable of bonding) with an alkaline agent and, to some extent, hydrolyzed (i.e., the covalent bonds were broken) to yield adhesives for wood bonding under dry conditions. However, these early soybean adhesives exhibited poor water resistance, strictly limiting their use to interior applications.

In addition, soybean adhesives common in the prior art exhibit a limited pot life. After only a few hours, the viscosity and performance of the alkaline-denatured soy flour mixture rapidly decreases (see FIG. 1). This reduction in performance is believed to be a result of some hydrolysis of the soy flour and the excessive breakdown of the secondary, tertiary and quaternary structures deemed to be important for the formation of both strong adhesive and cohesive bonds. Thus, a need exists for an adhesive demonstrating a balance between exposing sufficient functional groups for improved performance while retaining enough protein structure to maintain adhesive performance.

In the 1920's, phenol-formaldehyde (PF) and urea-formaldehyde (UF) adhesive resins were first developed. Phenol-formaldehyde and modified urea-formaldehyde resins were exterior-durable, but had high raw materials costs that initially limited their use. World War II contributed to the rapid development of these adhesives for water and weather resistant applications, including exterior applications. However, protein-based adhesives, mainly soy-based adhesives, continued to be used in many interior applications.

Emulsion polymers also became commonly used adhesives. Emulsion polymerization is used to produce high-volume polymers such as polyvinyl acetate (PVAc), polychloroprene (PC), various acrylates and a variety of styrene-butadiene-acrylonitrile copolymer resins. Emulsion polymerization is also used to polymerize methyl methacrylate, vinyl chloride, vinylidene chloride and styrene. In the past decade there has been a renewed interest in combining these emulsion polymers with soy-based adhesives due to the low cost of the soy-based adhesives and the need for formaldehyde-free adhesives for interior applications.

Currently, interior plywood, medium-density fiberboard (MDF) and particleboard (PB) are primarily produced using urea-formaldehyde resins. Although very strong, fast curing, and reasonably easy to use, these resins lack hydrolytic stability along the polymer backbone. This causes large amounts of free formaldehyde to be released from the finished products (and ultimately, inhaled by the occupants within the home). There have been several legislative actions to push for the removal of these resins from interior home applications (California Air Resource Board—CARB, 2007).

Soy-based adhesives can use soy flour, soy protein concentrates (SPC), or soy protein isolates (SPI) as the starting material. For simplicity, the present disclosure refers to all soy products that contain greater than 20% carbohydrates as “soy flour”. Soy flour is less expensive than SPI, but soy flour often contains high levels of activated urease (an enzyme that decomposes urea into ammonia), thus requiring the urease to be denatured (destroyed) without compromising the viscosity/solids ratio or performance of the final product. Soy flour also contains high levels of carbohydrates, requiring more complex crosslinking techniques (as crosslinking these carbohydrates results in the much improved water resistance of the soy-based adhesives).

Carbohydrates exist in soy flour as both water-soluble and water-insoluble fractions. The insoluble carbohydrate is primarily hemicellulose with small amounts of cellulose. The soluble fraction consists mainly of sucrose, raffinose and stachyose. Thermal processing of soy flour can result in significant carbohydrate-protein reactions. These reactions vary and are often quite broadly summarized as simply Mail lard type reactions.

SPC contains a greater amount of protein than soy flour, but contains less protein than SPI. Typically, SPC is produced using an alcohol wash to remove the soluble carbohydrates.

SPI is typically produced through an isoelectric precipitation process. This process not only removes the soluble sugars but also removes the more soluble low molecular weight-proteins, leaving behind mainly high molecular weight-proteins that are optimal for adhesion even without modification. As a result, SPI makes a very strong adhesive with appreciable durability. However, SPI is quite costly, and is therefore not an ideal source of soy for soy-based adhesives.

U.S. Patent Appn. No. 2004/0089418 to Li et al. (Li) describes soy protein crosslinked with a polyamido-amine epichlorohydrin-derived resin (PAE). Li describes these particular PAEs, which are known wet strength additives for paper and wood, in many possible reactions with protein functional groups. In Li, SPI is denatured with alkali at warm temperatures and then combined with a suitable PAE resin to yield a water-resistant bond. This aqueous soy solution must be prepared just prior to copolymerization (or freeze-dried) to allow for a suitable pot life. However, Li does not teach using soy carbohydrate with PAE. Li teaches soy-based adhesives made from SPI, which as described above, has already been stripped of soluble sugars and proteins. Therefore, Li does not teach or suggest the importance of denaturing soy for use with PAE, as the SPI used in Li already has an extensive thermal history.

U.S. Pat. No. 6,497,760 to Sun et al. (Sun) also teaches soy-based adhesives made from SPI as a starting material. Sun teaches that the SPI can be modified, but Sun does not teach or suggest modifying soy flour with urea to provide an improved soy-based adhesive. Urea is a known denaturant for adhesives having little to no urease activity, such as SPI. However, urea is problematic for soy flours as they contain moderate to high levels of urease activity. While it is known that SPI can be denatured with urea (see, e.g., Kinsella, J. Am. Oil Chem. Soc., March 1979, 56:244), Sun teaches away from using urea with soy flour because of the urease activity associated with it.

U.S. Pat. No. 3,220,851 to Rambaud describes a method of treating soya beans to improve their quality and usability in food processing. Rambaud describes cooking the soya in an aqueous solution to temperatures not to exceed 80° C. so as to remove the “undesirable” compounds such as urease and antitrypsin from the soya. Rambaud specifically teaches that the temperature of 80° C. constitutes a threshold value beyond which the speed of the degradation of the albumins increases rapidly, and it is therefore essential not to exceed this value. Rambaud also does not teach or suggest why removing urease or antitrypsin may be useful for the soya beans.

U.S. Pat. No. 7,345,136 to Wescott describes a method for denaturing soy flour in preparation for copolymerization by the direct addition of formaldehyde. Such a method, if applied to this invention would result in high ammonia levels and significant performance decreases. Alternatively, if the method of this invention is applied to the process of Wescott (7,345,136) immediate gelation is realized when formaldehyde is added to the denatured soy flour. This is a result of an insufficient level of denaturation for the process.

### SUMMARY OF THE INVENTION

The present invention provides a method of making stable adhesives by combining urea and soy flour that has been heated until denatured and substantially free of urease activity to form a stable soy/urea adhesive.

In one embodiment of the present invention, the soy flour is dispersed in water and then heated to temperatures of at least 81° C. to 100° C. for at least 15 to 500 minutes. The urea may be added to the soy flour before, during or after the soy flour is heated.

Urea may be added to the soy flour in amounts ranging between at most five parts urea to every one part soy flour to at least 0.25 parts urea to every one part soy flour. In one embodiment one part urea is added to one part soy flour, while in an alternative embodiment two parts urea is added to one part soy flour.

The soy/urea adhesive may further include a crosslinking agent, a diluent, or both. The crosslinking agent may be a formaldehyde-free crosslinking agent selected from polymeric methyl diphenyl diisocyanate (pMDI), amine epichlorohydrin adduct, epoxy, aldehyde or a urea aldehyde resin and any combination thereof. The crosslinking agent may also be a formaldehyde-containing crosslinking agent selected from formaldehyde, phenol formaldehyde, urea formaldehyde, melamine formaldehyde, melamine urea formaldehyde, phenol resorcinol and any combination thereof. The crosslinking agent is preferably added to the adhesive in an amount of at least 0.1 to 80 percent by weight.

The diluent may be reactive or non-reactive, and is preferably selected from the group consisting of glycerol, ethylene glycol, propylene glycol, neopentyl glycol and polymeric versions thereof.

The pH of the final adhesive may be adjusted using any traditional acid or base accordingly.

In another embodiment, the method of the present invention also provides a method of making a stable, aqueous soy/urea adhesive dispersion by adding an emulsified or dispersed polymer to the adhesive to form a stable urea/soy product dispersion. The method comprises heating soy flour until denatured and substantially free of urease, adding urea to the soy flour to form the soy/urea adhesive, and then combining the adhesive with an emulsified or dispersed polymer to form a stable, soy/urea dispersion.

Any emulsion or dispersion polymer can be modified by the adhesive of the present invention, including polyvinyl acetate (PVAc) or phenol formaldehyde dispersions.

The soy/urea adhesive dispersion may further include a crosslinking agent. The crosslinking agent may be a formaldehyde-free crosslinking agent selected from polymeric methyl diphenyl diisocyanate (pMDI), amine epichlorohydrin adducts, epoxy, aldehyde or a urea aldehyde resin and any combination thereof. The crosslinking agent may also be a formaldehyde-containing crosslinking agent selected from formaldehyde, phenol formaldehyde, urea formaldehyde, melamine formaldehyde, melamine urea formaldehyde, phenol resorcinol and any combination thereof. The crosslinking agent is preferably added to the dispersion in an amount of at least 0.1 to 80 percent by weight basis.

The method of the present invention may also include adding a spray- or freeze-drying step to produce a powder adhesive.

In the present invention, adding urea to soy flour that has been heated until denatured and substantially free of urease yields a soy/urea adhesive having an unexpected increase in stability, compatibility, dry or wet strength and biological resistance.

Further, the present invention advantageously uses regular baker-grade soy flour, available at a much lower cost than conventional sources of soy protein for adhesives. Typically, regular baker-grade soy flour does not offer any appreciable adhesive capabilities unless a denaturing step and crosslinking agent are used. Advantageously, the present invention demonstrates that urea can be used very effectively to denature and solvate soy flour with less urea and at temperatures higher than previously employed in the art. Thus, the present invention provides a stable soy/urea adhesive that exhibits improved properties even without a crosslinking agent.

In fact, the stable urea-denatured soy flour-based adhesives of the present invention offer improved resistance to biological attack for at least several months, which is very unexpected for a soy protein in a water environment. Further, this feature is not dependent on the type of soy flour used. Soy flours with high or low protein dispersibility indexes (PDI), or high or low protein contents, all show this same effect when the soy flour is substantially free of urease.

The novel methods of the present invention provide stable soy/urea adhesives and adhesive dispersions having several advantages over the prior art. First, the adhesives/dispersions of the present invention have much lower viscosities than other soy-based adhesives, which allows for easy transfer and applications. Second, the adhesives/dispersions of the present invention have a much higher resistance to biological degradation. Third, the adhesives/dispersions of the present invention exhibit a greatly improved stability. Fourth, the adhesives/dispersions of the present invention have a much higher percent solids. Fifth, the adhesives/dispersions of the present invention are more reactive toward, and demonstrate a superior shelf life with, certain crosslinking agents. Finally, the adhesives/dispersions of the present invention provide a unique scavenging capability to reduce formaldehyde emissions in wood.

### BRIEF DESCRIPTION OF THE FIGURES

FIG. 1 illustrates the denaturation profile of soy flour with NaOH;

FIG. 2 illustrates the pH stability of soy/urea adhesives of the present invention over time;

FIG. 3 illustrates the pH and pH Stability of adhesives of the present invention as a function of soy heat temperature;

FIG. 4 illustrates the viscosity stability of soy/urea adhesives of the present invention over time;

FIG. 5 illustrates the viscosity stability of soy/urea (1:1) adhesives of the present invention with 5% and 20% PAE over time;

FIG. 6 illustrates the ABES strength development for soy/urea (1:1) adhesives of the present invention (pH 4.5) with 5% and 20% PAE over time;

FIG. 7 illustrates the ABES strength development for soy/urea (1:1) adhesives of the present invention (pH 7.0) with 5% and 20% PAE over time;

FIG. 8 illustrates the ABES strength development for soy/urea (1:1) adhesives of the present invention (pH 10.0) with 5% and 20% PAE over time;

FIG. 9 illustrates the ABES strength development for soy/urea (1:1) adhesives of the present invention (pH 4.7 and 7.0) with 5% PAE over time;

FIG. 10 illustrates the ABES/Instron dry and wet strength for soy/urea/PAE adhesives of the present invention;

FIG. 11 illustrates the ABES/Instron wet strength retention;

FIG. 12 illustrates the ABES strength development for soy/urea (1:1) adhesives of the present invention (pH 7.0) with pMDI over time;

FIG. 13 illustrates the ABES strength development comparison for soy/urea adhesives of the present invention having 20% pMDI;

FIG. 14 illustrates the ABES/Instron wet strength improvement for soy/urea adhesives of the present invention having 5% PAE versus soy/urea adhesives of the present invention having various protein contents;

FIG. 15 illustrates the viscosity and pH stability of PVAc/soy/urea adhesives of the present invention;

FIG. 16 illustrates the ABES/Intron Dry/Wet Shear Strength of PVAc/soy/urea adhesives of the present invention;

FIG. 17 illustrates the ABES/Instron Dry/Wet Shear Strength of PVAc/Soy/Urea adhesives of the present invention (solids normalized);

FIG. 18 illustrates the ABES/Instron Dry/Wet Shear Strength of PVAc/Soy/Urea adhesives of the present invention (low urease soy);

FIG. 19 illustrates the ABES/Instron Dry/Wet Shear Strength of PVAc/Soy/Urea adhesives of the present invention (75% PVAc);

FIG. 20 illustrates the Hot. Press 3-Ply Shear Strengths (Wet/Dry) of PVAc/Soy/Urea Resins (Maple);

FIG. 21 illustrates the Cold Press 3-Ply Shear Strengths (Wet/Dry) of PVAc/Soy/Urea Resins (Maple);

FIG. 22 illustrates the ABES/Instron Dry/Wet Shear Strength of Crosslinker Modified PVAc/Soy/Urea adhesives of the present invention (75% PVAc); and

FIG. 23 illustrates the ABES/Instron Analysis of Soy/Urea/PF Dispersions of the present invention.

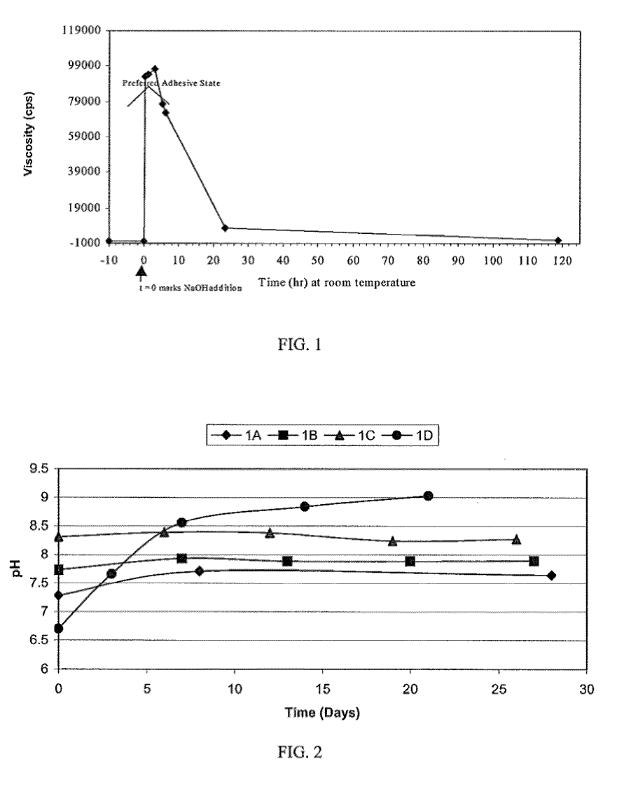

### DETAILED DESCRIPTION OF THE INVENTION

In the specification and in the claims, the terms “including” and “comprising” are open-ended terms and should be interpreted to mean “including, but not limited to . . . ” These terms encompass the more restrictive terms “consisting essentially of” and “consisting of.”

As used herein and in the appended claims, the singular forms “a”, “an”, and “the” include plural reference unless the context clearly dictates otherwise. As well, the terms “a” (or “an”), “one or more” and “at least one” can be used interchangeably herein. It is also to be noted that the terms “comprising”, “including”, “characterized by” and “having” can be used interchangeably.

Unless defined otherwise, all technical and scientific terms used herein have the same meanings as commonly understood by one of ordinary skill in the art to which this invention belongs. All publications and patents specifically mentioned herein are incorporated by reference in their entirety for all purposes including describing and disclosing the chemicals, instruments, statistical analyses and methodologies which are reported in the publications which might be used in connection with the invention. All references cited in this specification are to be taken as indicative of the level of skill in the art. Nothing herein is to be construed as an admission that the invention is not entitled to antedate such disclosure by virtue of prior invention.

The present invention provides a novel adhesive and adhesive dispersion produced by combining urea with soy flour that has been heated until denatured and substantially free of urease activity. The urea may be added before, during, or after the heat denaturing process.

By “stable” we mean an adhesive that remains viscous and pH-stable for extended periods of time at room temperature. By “pH stable” we mean that the pH stays within one unit for at least twenty days. By “viscous stable” we mean that the Brookfield viscosity of the adhesive remains within 500 centipoises for at least 20 hours.

By “denatured” we mean proteins that have lost some of their structure (quaternary, tertiary and secondary structure) through the application of some external stress or compound, such as, for example, treatment of proteins with strong acids or bases, high concentrations of inorganic salts, organic solvents (e.g., alcohol or chloroform), or heat. Soy flour, when properly denatured, is an excellent adhesive. Once denatured, proteins contained within the soy flour “uncoil” from their native structure, thereby exposing the more hydrophilic amide groups of the protein backbone. Controlling the extent of denaturing is critical to producing an adhesive with increased strength and stability according to the methods of the present invention.

By “substantially free” we mean that conventional tests will not recognize any significant amounts of urease present in the heated soy flour, typically measured by a change in pH over time. Thus, soy flours that are “substantially free” of urease activity will exhibit a pH change of less than one unit over twenty days in the presence of urea at room temperature.

While a soy flour that is substantially free of urease is denatured, a soy flour that has been denatured is not necessary substantially free of urease. The novelty of the present invention is that the inventors have determined that it is necessary to heat the soy flour to elevated temperatures above those considered necessary to denature a soy flour to render the soy flour substantially free of urease, and therefore useful for the stable soy/urea adhesive.

By “elevated” we mean heating the soy flour to temperatures of at least 81° C.-100° C. for a period of at least 15-500 minutes. When soy flour is heated to temperatures of at least 81° C. −100° C. for a period of at least 15-500 minutes, the soy flour is denatured and is also substantially free of all natural urease activity.

One aspect of the present invention provides a method for making a stable adhesive, the method comprising the steps of providing an aqueous suspension of soy flour, heating the soy flour to a temperature of at least 81° C. until denatured and substantially free of urease; and adding urea to the soy flour, wherein a stable aqueous soy/urea adhesive is formed

The present invention yields stable aqueous soy/urea adhesives regardless of the PDI of the soy flour used. The Protein Dispersibility index (PDI) is a means of comparing the solubility of a protein in water, and is widely used in the soybean product industry. A sample of the soybeans are ground, mixed with a specific quantity of water, and then blended together at a specific rpm for a specific time. The protein content of the resulting mixture and original bean flour are then measured using a combustion test, and the PDI is calculated as the percentage of the protein in the mix divided by the percentage in the flour. For instance, a PDI of 100 indicates total solubility. PDI is affected not only by the type of soybean used, but also by any manufacturing processes used on the soy. For instance, heat can lower the PDI of a soybean sample. The PDI required of a soy flour is dependent on the purpose to which the soybeans are to be put. The utility of the present invention is that the soy/urea adhesive of the present invention can use either high or low PDI soy flour to yield the stable adhesives of the present invention.

While it is absolutely essential to heat the soy flour of the present invention until denatured and substantially free of urease, the time at high temperature required to both denature and remove substantially all urease from the soy flour depends on the PDI of the soy and the amount of modification required. The soy flour is heated to at least 81° C. The flour can be heated up to 100° C. Preferably the temperature for heating the soy flour is at least 82° C., more preferably at least 85° C. Preferably the soy flour is not heated above 98° C., more preferably not above 95° C. The heating time required also depends on the type of crosslinking agent chosen (if desired) to provide a stable, soy/urea adhesive having additional water resistance. Alkali denaturizing and/or excessive heat denaturing greater using temperatures greater than 100° C. will result in over denaturing, resulting in significant performance and stability reduction, and a high viscosity. One of skill in the art will be able to determine the heating time needed based on these variables using the examples provided below. Preferably the heating time is at least 1.5 minutes. Preferably the heating time is from 15 minute to 500 minutes, more preferably from 20 minutes to 200 minutes. The only denaturing process useful in the present invention is denaturing by heating to between 81° and 100° C. No other denaturant, as for example alkali is used in the present invention. The pH of the aqueous soy is not adjusted before or during heating. Generally the pH of the aqueous soy prior to heating is near neutral (pH of 6.5 to 7.5).

Conventional heat-denatured soy flour exhibits very high viscosities and low solids contents, making it difficult to transport and store, as it begins to degrade or “spoil” within a few hours. However, adding urea to the soy flour, as in the present invention, either before, during or after the soy flour has been heated until denatured and substantially free of urease activity, to produce the stable urea/soy adhesives of the present invention not only reduces the viscosity of the adhesive but also, quite unexpectedly, greatly improves the biological resistance, solvation, chemical reaction and denaturation of the adhesive.

Further, the viscosity and pH stability of the adhesive are greatly improved as compared to conventional soy adhesives of the prior art. This improvement exists even compared to conventional adhesives of the prior art using a crosslinking agent. Adding urea to the denatured, substantially urease free soy flour, either before or after the soy flour has been denatured and substantially urease free, according to the methods of the present invention is critical for viscosity control, compatibility, stability and solvation (which increases the reactivity toward suitable crosslinking agents) of the adhesive. Unexpectedly, the inventors have now determined that the urea can be added before or after the soy flour has been heated until denatured and substantially free of urease. While the stable adhesive of the present invention requires the soy flour be both denatured and substantially free of urease, adding the urea before heating does not inhibit the denaturing step. However, adding urea to the soy flour after being heated to denature and remove substantially all the urease in the soy flour allows for low viscosity mixing and also allows the urea to react with the soy flour components, allowing, for example, carbamylation of the soy flour proteins (which can be desirable in certain situations known to one of skill in the art).

The amount of urea added to the soy flour depends on the needs of the soy/urea adhesive or dispersion. For instance, the urea content may be adjusted to control the flow characteristics or glass transition temperature (Tₐ) of the final adhesive. This allows the adhesive/dispersion of the present invention to be spray dried and converted into a useable powder adhesive resin.

In one embodiment, the amount of urea added to the soy flour can be from about five parts urea to one part soy flour (solids/solids) to about 0.25 parts urea to one part soy flour (solids/solids); most preferably between two parts urea to one part soy flour to about 0.5 parts urea to one part soy flour. The soy flour can be denatured before, during or after the addition of the urea.

The adhesive of the present invention can be added to any emulsion or dispersion polymers, such as, for example, polyvinyl acetate (PVAc) emulsions and phenol formaldehyde dispersions, to yield a stable adhesive dispersion. By “emulsion” we mean a suspension of small globules of one liquid in a second liquid where the first liquid will not mix (i.e., oil in vinegar). By “dispersion” we mean a two-phase adhesive system in which one phase is suspended in a liquid. For the sake of convenience, the emulsion or dispersion of the present invention is referred to throughout this document as an “adhesive dispersion” or “dispersion.” This is not meant to limit the scope of the invention, but is merely for ease of reading.

Typically, adding unmodified soy flour or NaOH-denatured soy flour directly to emulsified polymer yields resins having poor stability and compatibility. In contrast, adding the stable soy/urea adhesive of the present invention to an emulsion or dispersed polymer yields a stable, highly compatible adhesive dispersion useful in many industrial applications. Further, the combination is accomplished by simple blending techniques using commercial mix tanks, thin tanks or reactors known to one of skill in the art. The temperature of the blend is not considered to be critical and room temperature is typically employed, although it may be desirable and acceptable to combine the stable soy/urea adhesive of the present invention with the emulsion or dispersed polymer at higher temperatures depending on the needs of the user. The adjustment of the final pH with acids or bases may be required to ensure optimal stability of the dispersion. However, these adjustments are typically quite modest and are known to one of skill in the art. For instance, minor adjustments necessary for the stability of the emulsion or dispersion may be desired.

The stable soy/urea adhesive or dispersion of the present invention may be used as is or may be further improved by adding a suitable crosslinking agent(s). Crosslinking agents are typically added to resins and adhesives to provide additional or manipulate existing properties of the adhesive, such as water resistance, solubility, viscosity, shelf-life, elastomeric properties, biological resistance, strength, and the like. The role of the crosslinking agent, regardless of type, is to incorporate an increase in the crosslink density within the adhesive itself. This is best achieved with crosslinking agents that have several reactive sites per molecule.

The type and amount of crosslinking agent used in the stable soy/urea adhesive or dispersion of the present invention depends on what properties are desired. Additionally, the type and amount of crosslinking agent used may depend on the characteristics of the soy flour used in the adhesive. For instance, if a stable soy/urea adhesive or dispersion according to the present invention having improved water resistance is desired, the type and amount of crosslinking agent added to the adhesive/dispersion will depend on the amount of carbohydrates in the soy flour used to make the adhesive. The amount of carbohydrates in the flour can range from 1-60%, depending on the pretreatment of the soy. Some flours, such as soy protein concentrates (SPC), typically contain 15-30% carbohydrates by weight, while other soy flours can have 40-50% carbohydrates. As carbohydrates are the main cause of poor water resistance within soy flour, crosslinking these carbohydrates results in adhesives having improved water resistance, improved strength (both dry and wet), less water uptake and less swelling (which can lead to the wet de-bonding of the adhesives).

Any crosslinking agent known to the art may be used in the method of the present invention. For instance, the crosslinking agent may or may not contain formaldehyde. Although formaldehyde-free crosslinking agents are highly desirable in many interior applications, formaldehyde-containing crosslinking agents remain acceptable for some exterior applications.

Possible formaldehyde-free crosslinking agents for use with the adhesives of the present invention include isocyanates such as polymeric methyl diphenyl diisocyanate (pMDI), amine-epichlorohydrin adducts, epoxy, aldehyde and urea-aldehyde resins capable of reacting with soy flour. In one embodiment the formaldehyde-free crosslinking agents comprises a polyamidoamine epichlorohydrin (PAE) in amounts ranging from 0.1 to 80%.

Amine-epichlorohydrin resins are defined as those prepared through the reaction of epichlorohydrin with amine-functional compounds. Among these are polyamidoamine-epichlorohydrin resins (PAE resins), polyalkylenepolyamine-epichlorohydrin (PAPAE resins) and amine polymer-epichlorohydrin resins (APE resins). The PAE resins include secondary amine-based azetidinium-functional PAE resins such as Kymene™ 557H, Kymene™ 557LX, Kymene™ 617, Kymene™ 624 and ChemVisions™ CA1000, all available from Hercules Incorporated, Wilmington Del., tertiary amine polyamide-based epoxide-functional resins and tertiary amine polyamidourylene-based epoxide-functional PAE resins such as Kymene™ 450, available from Hercules Incorporated, Wilmington Del. A suitable crosslinking PAPAE resin is Kymene™ 736, available from Hercules Incorporated, Wilmington Del. Kymene™ 2064 is an APE resin that is also available from Hercules Incorporated, Wilmington Del. These are widely used commercial materials. Their chemistry is described in the following reference: H. H. Espy, “Alkaline-Curing Polymeric Amine-Epichlorohydrin Resins”, in Wet Strength Resins and Their Application, L. L. Chan, Ed., TAPPI Press, Atlanta Ga., pp. 13-44 (1994). It is also possible to use low molecular weight amine-epichlorohydrin condensates as described in Coscia (U.S. Pat. No. 3,494,775) as formaldehyde-free crosslinkers.

Possible formaldehyde-containing crosslinking agents include formaldehyde, phenol formaldehyde, urea formaldehyde, melamine urea formaldehyde, melamine formaldehyde, phenol resorcinol and any combination thereof. In one embodiment the formaldehyde-containing crosslinking agents comprises phenol formaldehyde in amounts ranging from 1 to 90%.

Regardless of the specific crosslinking agent(s) used, the crosslinking agent is typically added to the adhesive or dispersion just prior to use (such as in making a lignocellulosic composite), but may be added days or even weeks prior to use in some situations.

In some applications, it may be desirable to add a diluent to better solvate, further denature or otherwise modify the physical properties of the soy/urea adhesive/dispersion. Possible diluents/modifiers include polyols such as glycerol, ethylene glycol, propylene glycol or any other hydroxyl-containing monomer or polymeric material available, defoamers, wetting agents and the like that are commonly employed in the art. Other diluents that serve only to extend the solids are also acceptable, such as flours, talcs, clays and the like.

These diluents/modifiers may be incorporated at levels ranging from 0.1 to upwards of 70% of the total adhesive. These may be incorporated during any step of the process including before, during or after the urease deactivation heating step.

The pH of the soy/urea adhesives of the present invention is less than twelve, preferably less than ten. In one version, adhesives having a pH of between four and ten exhibit optimum stability and compatibility. One of skill in the art will understand how to both manipulate the pH of the adhesive (described in the examples below) and what applications require an adhesive/dispersion having a higher or lower pH.

The stable soy/urea adhesive of the present invention can be used in many industrial applications. For instance, the adhesive/dispersion may be applied to a suitable substrate in amounts ranging from 1 to 25% by weight, preferably in the range of 1 to 10% by weight and most preferably in the range of 2 to 8% by weight. Examples of some suitable substrates include, but are not limited to, a lignocellulosic material, pulp or glass fiber. The adhesive can be applied to substrates any means known to the art including roller coating, knife coating, extrusion, curtain coating, foam coaters and spray coaters such as a spinning disk resin applicator.

One of skill will understand how to use adhesives/dispersions of the present invention to prepare lignocellulosic composites using references known to the field. See, for example, “Wood-based Composite Products and Panel Products”, Chapter 10 of Wood Handbook—Wood as an Engineering Material, Gen. Tech. Rep. FPL-GTR-113, 463 pages, U.S. Department of Agriculture, Forest Service, Forest Products Laboratory, Madison, Wis. (1999). A number of materials can be prepared using the adhesive/dispersion of the invention including particleboard, oriented strand board (OSB), waferboard, fiberboard (including medium-density and high-density fiberboard), parallel strand lumber (PSL), laminated strand lumber (LSL), oriented strand lumber (OSL) and other similar products. Lignocellulosic materials such as wood, wood pulp, straw (including rice, wheat or barley), flax, hemp and bagasse can be used in making thermoset products from the invention. The lignocellulosic product is typically made by blending the adhesive with a substrate in the form of powders, particles, fibers, chips, flakes fibers, wafers, trim, shavings, sawdust, straw, stalks or shives and then pressing and heating the resulting combination to obtain the cured material. The moisture content of the lignocellulosic material should be in the range of 2 to 20% before blending with the adhesive of the present invention.

The adhesive of the present invention also may be used to produce plywood or laminated veneer lumber (LVL). For instance, in one embodiment, the adhesive may be applied onto veneer surfaces by roll coating, knife coating, curtain coating, or spraying. A plurality of veneers is then laid-up to form sheets of required thickness. The mats or sheets are then placed in a press (e.g., a platen), usually heated, and compressed to effect consolidation and curing of the materials into a board. Fiberboard may be made by the wet felted/wet pressed method, the dry felted/dry pressed method, or the wet felted/dry pressed method.

In addition to lignocellulosic substrates, the adhesives of the present invention can be used with substrates such as plastics, glass wool, glass fiber, other inorganic materials and combinations thereof.

The following examples are, of course, offered for illustrative purposes only, and are not intended to limit the scope of the present invention in any way. Indeed, various modifications of the invention in addition to those shown and described herein will become apparent to those skilled in the art from the foregoing description and the following examples and fall within the scope of the appended claims.

### EXAMPLES

### Examples and Evaluation Methodologies

The following characteristics of the soy flour/urea adhesives were evaluated:

1) Physical Properties—Brookfield viscosity (LVT @30 and 60 RPMs with spindles 1-4 depending upon the viscosity of the product, oven solids (150° C./1 hr or 125° C./1.5 hr, this does result in some loss of free urea and thus explains why the theoretical values are higher than the measure values), pH, and room temperature viscosity and biological stability (as determined by the obvious onset of the soy rotting or spoiling similar to milk) are the main characteristics that we are concerned with.

2) Dry strength development—Shear strength of two plys pressed using the Automated Bonding Evaluation System (ABES) from AES, Inc. This is used for determining the strength of the adhesive bond as developed over time under specific pressing times/temperatures. 120° C. was used in all examples. The results are plotted relative to press time to determine the relative strength development of different adhesives as a function of time. Specimens are prepared in accordance with the HRT ABES/Instron Procedure but tested within the ABES unit itself within seconds after pressing.

3) Wet strength retention—Wet failure often occurs when the glue line is not capable of properly distributing the stresses that build within the wood-glue interface as a result of expansion and contraction of the wood during the wetting and drying processes. Wet strength retention is calculated as the percent of dry strength retained after soaking.

4) Interior Plywood Qualification—Samples are prepared using the Douglas Fir 3-Ply Procedure outlined below and then subjected to ANSI/HPVA HP-1-2004 4.6 “Three-cycle Soak Test” standard for interior grade plywood.

### HRT ABES/Instron Procedure.

Sample Preparation: Wood samples were stamped out using the Automated Bonding Evaluation System (ABES) stamping apparatus from Eastern White Pine veneer such that the final dimensions were 11.7 cm along the grain, 2.0 cm perpendicular to the grain and 0.08 cm thick. The adhesive to be tested was applied to one end of the sample such that the entire overlap area is covered, generally being in the range of 3.8-4.2 mg/cm² on a wet basis. The sample was then bonded to a second veneer (open time of less than 15 seconds to ensure excellent transfer) and placed in the ABES unit such that the overlap area of the bonded samples was 1.0 cm by 2.0 cm. Unless otherwise noted, all samples were pressed for 2.0 minutes at 120° C., with 9.1 kg/cm² of pressure. All bonded samples were then allowed to condition for at least 48 hours in a controlled environment at 22° C. and 50% relative humidity.

Strength Testing: For each resin, ten samples were prepared in the manner described above. After conditioning, five of the ten samples were tested using an Instron 1000 with a crosshead speed of 10 mm/min. Maximum load upon sample breakage was recorded. These were termed the dry strength samples. The remaining five samples were placed in a water bath at 22° C. for four hours. The samples were removed from the water bath and immediately tested in the manner described above. These samples were termed the wet samples. Special grips were manufactured to allow for the thin samples to be held within the Instron. For each resin, the value reported is an average of the five samples. The error reported is the standard deviation. Typical coefficients of variations (COVs) for this method are around 15% for both dry and wet evaluations; this is considered to be excellent in light of the variability within the wood itself.

### Douglas Fir 3-Ply Preparation Procedure

Sample Preparation: Veneers used were 8″ by 8″ and ⅙″ thick Douglas fir. The adhesive to be tested was first applied to one side of the center veneer. The top veneer is then placed over this side such that the grain of the two veneers is perpendicular. There is no specific open time for this process. The adhesive is then applied to the other side of the center veneer and the bottom veneer is placed over this side such that the grain of the two veneers is perpendicular. Typical adhesive loads range from 21.5 to 22.5 mg/cm² per glue line on a wet basis. The assembled three-ply is then pressed for five minutes at 150° C. with 11.0 kg/cm² of pressure. Samples are conditioned at 26° C. and 30% relative humidity for at least 48 hours before testing.

Sample Testing: Samples were tested using ANSI/HPVA HP-1-2004 4.6 “Three-cycle Soak Test.”

### Maple 3-Ply Preparation Procedure

Sample Preparation: Veneers used were 8″ by 8″ and ⅙″ thick Maple veneers. The adhesive to be tested was first applied to one side of the center veneer. The bottom veneer is then placed over the adhesive applied side of the center veneer such that the grain of the two veneers is perpendicular. There is no specific open time for this process. This two-ply assembly is then turned over such that the center veneer is on top. The adhesive is then applied to the other side of the center veneer and the top veneer is placed over this side such that the grain of the two veneers is again perpendicular. Typical adhesive loads range from 21.5 to 22.5 mg/cm² per glue line on a wet basis. The assembled three-ply is then pressed for 5 minutes at 150° C. with 11.0 kg/cm² of pressure. Samples are conditioned at 26° C. and 30% relative humidity for at least 48 hours before testing.

Sample Testing: Samples were tested in accordance with ASTM D906

Raw materials for these examples are as follows:

Soy Flour supplied by ADM (Decatur, Ill.) 70 High PDI-A7B grade (A7B), 4.7% moisture and Cargill (Minneapolis, Minn.)<20 Very Low PDI-toasted soy (CG4), and 20 low PDI-toasted soy (TS); Soy Protein Concentrates (SPC) supplied by ADM (AVF); Soy Protein Isolates (SPI) supplied by ADM, SPI Profam 974; Urea (Commercial Grade) purchased from Univar; PAE, ChemVisions™ CA 1000 PAE, supplied by Hercules, pH 2.62, 150 C/1 hr oven solids=20.04%; pMDI, PAPI™, supplied by Dow Chemical (Midland, Mich.); PVAc, DUR-A-FLEX™, supplied by Franklin, Int. of (Columbus, Ohio); epoxy resin ANCAREZ AR550, supplied by Air Products and Chemicals Inc. of Allentown, Pa.; and Arolon 850-W-45, supplied by Reichold of Bridgeport, N.J.

### Example 1

### Methods of Preparing Soy/Urea Adhesives

Soy flour was heat-denatured and then reacted with urea to produce stable soy/urea aqueous products.

Preparation Procedure: (1A-1D): Water was charged into a three-neck round bottom flask equipped with a heating mantle, temperature controller, reflux condenser and mechanical stirrer. The soy flour was added to the water at room temperature over a period of two to five minutes. The mixture was stirred for five minutes to homogeneity and then heated to 90° C. denaturing temperature over fifteen to thirty minutes. The reaction was held at the set temperature +/−0.5° C. for one hour with stirring at which time the urea was added to the heat denatured soy and held for an additional hour at the set point. The reaction was cooled to 25° C. on ice/water bath and stored for use in plastic bottles at room temperature. Sample 1D was identical to 1B except a lower PDI soy (CG4) was used and the temperature was reduced from 90° C. to 50° C.

Temperature Optimization Study-Preparation Procedure: (1E-1I): Water was charged into a three-neck round bottom flask equipped with a heating mantle, temperature controller, reflux condenser and mechanical stirrer. The soy flour was added to the water at room temperature over a period of two to five minutes. The mixture was stirred for five minutes to homogeneity and then heated to the desired denaturing temperature over thirty to forty-five minutes. The reaction was held at the set temperature +/−0.5° C. for 30 minutes with stirring at which time the heat was removed and the urea was added to heat denatured soy. The temperature cooled to 50-60° C. from the dissolution of the urea and was further cooled and held at 50° C. for 1 hour. The reaction was then cooled to 25° C. on ice/water bath and stored for use in plastic bottles at room temperature.

TABLE 1
Formula for Example 1A (70 PDI, 90° C.)

| Sequence | Ingredient | Amount (g) | Solids | % to Soy |
|---|---|---|---|---|
| 01 | Water | 636.1 | 0 | |
| 02 | Soy Flour-A7B | 150.0 | 143.0 | |
| 03 | Urea | 71.5 | 71.5 | 50 |
| Totals | | 857.6 | 214.5 | |
| % Solids | | | 25.0 | |

TABLE 2
Formula for Example 1B (70 PDI 90° C.)

| Sequence | Ingredient | Amount (g) | Solids | % to Soy |
|---|---|---|---|---|
| 01 | Water | 660.3 | 0 | |
| 02 | Soy Flour-A7B | 150.0 | 143.0 | |
| 03 | Urea | 143.0 | 143.0 | 100 |
| Totals | | 953.3 | 286.0 | |
| % Solids | | | 30.0 | |

TABLE 3
Formula for Example 1E-1I (20 PDI-various temperatures ° C.)

| Sequence | Ingredient | Amount (g) | Solids | % to Soy |
|---|---|---|---|---|
| 01 | Water | 200.2 | 0 | |
| 02 | Soy Flour-TS | 47.4 | 45.0 | |
| 03 | Urea | 90.0 | 90.0 | 200 |
| Totals | | 337.6 | 135.0 | |
| % Solids | | | 40.0 | |

Discussion: The products from Examples 1A-1I all resulted in very homogenous mixtures. Physical properties for all the soy/urea adhesives are shown in Table 4. As expected, the viscosity is greatly reduced and the solids could be increased at higher levels of urea and will retain low viscosity (Example 1C vs 1A). The small increase in the initial pH could be from some thermal breakdown on the urea, as the urea was heated in 1A-1D, which elevates the pH. No ammonia smell was observed in any of the samples even after three months. The pH and viscosity stabilities of 1A-1D (FIGS. 2 and 4, respectively) clearly show how the all 90° C. products offer excellent stability and are also suitable for transportation via traditional liquid pumping methodologies. Interestingly, the 50° C. product is much thinner, but offers much poorer pH and viscosity stability than the 90° C. examples. It appears that the 50° C. sample benefits from less temperature with respect to reduced viscosity and higher solids, but suffers from poor pH stability, that ultimately leads to poor viscosity stability, as the urease has not been completely destroyed in the native soy under these mild conditions, even when starting with a low PDI flour (CG4).

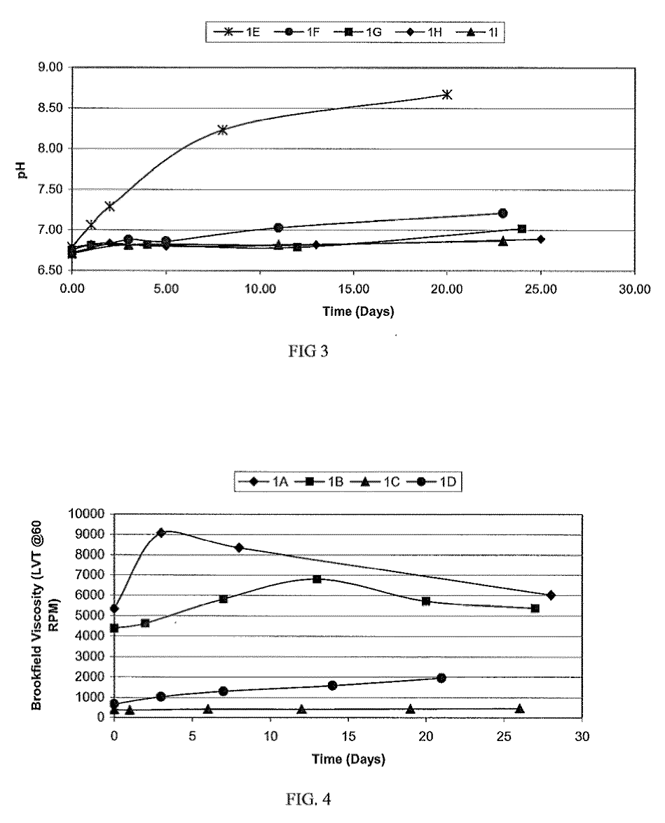

As example 1A-C demonstrated that 90° C. was successful in producing “substantially free” urease soy and showed the ability to make “stable” adhesives, but example 1D (only 50°) was not successful (pH was very unstable), we decided to further explore the range of acceptable denaturing temperatures, thus, an additional study was conducted (1E-1I), with the formula shown in Table 3 and the results in Table 4 and FIG. 3. The only variable in this study was the temperature at which the soy was maintained prior to the incorporation of the urea. The soy/urea ratio of 1:2 was used to maximize the effects of the potential insufficient heating on the pH stability. In these experiments the temperature was monitored with both a thermocouple and a traditional thermometer to ensure the accuracy of the readings. In all experiments the temperature was never allowed to deviate from the set point by more than 0.5° C. FIG. 3 shows the pH and pH stability of the final resins as a function of the soy cook temperature; the aging study and measurements were all taken at room temperature. Excellent pH stability is important for our invention and this data clearly demonstrates the importance of employing a soy heat temperature of GREATER than 80° C. The results clearly show that 78° C. is far too low a temperature and even. 80° C. is not sufficient for long term pH stability; that is, there is still a noticeable increase in pH over the first two weeks with an 80° C. cook step, this makes the adhesive not commercially viable. pH stability for the 82.5 and higher experiments all appear to be comparable and acceptable for long shelf life resins. This data supports the required temperature of 81° C. minimum for the production of pH stable adhesives. Moreover, although the higher the temperatures have no negative effect on the pH stability, higher temperatures due result in additional soy denaturing that does lead to higher viscosity.

Also of interest, Example 1D did not show the biological resistance of the other resins and began to “spoil” after less than three weeks, probably a result of a decreased urea level due to urease degradation (note large difference in theoretical versus actual solids and the presence of the ammonia odor). The shear thinning behavior of the products often makes it challenging to obtain a consistent viscosity reading and is a probable reason for some of the shapes observed in FIG. 4. This shear-thinning feature is observed by all aqueous soy protein containing products, but it is actually slightly lower than for typical alkaline denatured products and, also, seems to lesson slightly as a function of total urea content, which could aid in the application of these products. Most importantly, the products from Examples 1A-1I are still fluid and stable from biological degradation after more than three months of setting at room temperature. A simple heat-denatured soy flour (no urea but reacted at 90° C.) results in non-flowing thick products at concentrations of less that 15% that show a great deal of biological degradation in as little as 24 hours. Thus, unexpectedly, the urea is also serving as an essential biocide/preservative in these products.

TABLE 4
Characteristics of Soy/Urea Resins

| | Temp | | Solids | | Brookfield Viscosity | | |
|---|---|---|---|---|---|---|---|
| Example | ° C. | Soy/Urea | Theoretical | Oven | @ 60 RPM | @30 RPM | pH |
| 1A | 90.0 | 2/1 | 25.0 | 24.2 | 5340 | 7760 | 7.28 |
| 1B | 90.0 | 1/1 | 30.0 | 27.4 | 4380 | 6360 | 7.73 |
| 1C | 90.0 | 1:2 | 35.0 | 30.0 | 400 | 540 | 8.31 |
| 1D | 50.0 | 1/1 | 30.0 | 22.9 | 670 | 924 | 6.70 |
| 1E | 78.0 | 1:2 | 40.0 | | | 684 | 6.79 |
| 1F | 80.0 | 1:2 | 40.0 | | | 536 | 6.72 |
| 1G | 82.5 | 1:2 | 40.0 | | | 688 | 6.75 |
| 1H | 85.9 | 1:2 | 40.0 | | | 732 | 6.78 |
| 1I | 87.0 | 1:2 | 40.0 | | | 852 | 6.71 |

### Example 2: Comparative Examples

Some recent work has demonstrated the known dry and wet adhesive strengths from non-crosslinked soy protein isolates. Comparing these adhesives to the adhesives of the present invention demonstrate the improvements that can be realized with a low cost, high carbohydrate containing soy flour.

Example 2A is a low temperature urea-denatured product prepared according to Sun U.S. Pat. No. 6,497,760 except that 23.9% solids were used instead of 14.0%. Additionally, Sun's product was freeze-dried and the present product was used immediately.

Preparation Procedure: Water and urea were charged to a three-neck round bottom flask equipped with a heating mantle, temperature controller, reflux condenser and mechanical stirrer. The solution was heated to 25° C. at which time the SPI was added over a fifteen min. period. The mixture was maintained at 25±2° C. for one hour with stirring. The reaction product was then stored for use at room temperature.

TABLE 5
Formula for Example 2A

| Sequence | Ingredient | Amount (g) | Solids | % to Soy |
|---|---|---|---|---|
| 01 | Water | 121.2 | 0 | |
| 02 | SPI | 10.0 | 9.44 | |
| 03 | Urea | 28.8 | 28.8 | 305 |
| Totals | | 160 | 38.2 | |
| % Solids | | | 23.9 | |

Example 2B is an alkali denatured soy product prepared according to Example 1.3 from Sun, U.S. Pat. No. 6,497,760. These products were excellent comparative examples for the strength requirements for Douglas Fir interior plywood because these products are capable of passing an interior grade plywood test if unconventionally applied to both sides of the interior veneers. (ANSI/HPVA HP-1-2004 4.6 “Three-cycle Soak Test”).

Preparation Procedure: Water was charged into a three-neck round bottom flask equipped with a heating mantle, temperature controller, reflux condenser and mechanical stirrer. The SPI was added over two to five minutes. The reaction was stirred for 30 minutes at 22° C. The 50% NaOH was then added and the reaction was heated to 50° C. The reaction was held at 2° C. for two hours with stirring. The reaction was cooled to 25° C. and stored for use.

TABLE 6
Formula for Example 2B

| Sequence | Ingredient | Amount (g) | Solids | % to Soy |
|---|---|---|---|---|
| 01 | Water | 180.9 | 0 | |
| 02 | SPI | 30.0 | 28.32 | |
| 03 | 50% NaOH | 0.3 | 0.15 | 0.53 |
| Totals | | 211.2 | 28.5 | |
| % Solids | | | 13.5 | |

Discussion: The physical characteristics of these two products (Examples 2A and 2B) are shown in Table 7. These products are much thicker than the products shown in Table 4 at comparable solids. Most notably, the high urea Example 2A is twenty-five times as thick as the soy flour 0.5 S/U example; the comparative product also exhibits a lower percent solids (23.9 vs. 35.0). This high viscosity, low solids situation becomes even more of an issue with the alkali modified product (Example 2B). The present method produces soy flour/urea products that are much thinner and at higher solids than previous SPI resins can offer. These products were tested using both the HRT ABES/Instron Procedure and the Douglas Fir 3-Ply Preparation Procedure.

TABLE 7
Characteristics of Soy Comparative Resins

| | | Solids | | Brookfield Viscosity | | |
|---|---|---|---|---|---|---|
| Example | Soy/Urea | Theoretical | Oven | @ 60 RPM | @30 RPM | pH |
| 2A | 1/3 | 23.9 | 22.1 | 9810 | 15960 | 7.17 |
| 2B | NA | 13.5 | 14.1 | >10,000 | >20,000 | 9.97 |

### Examples 3 to 5

Soy Flour/Urea with PAE: Although the soy flour/urea adhesives can be used as a stand-alone adhesive, the water resistance is limited. A crosslinking agent may be added to provide additional protection against water swelling and, thus, enhancing the wet strength. The crosslinking agent introduces additional crosslink density into the products.

Examples 3-5 demonstrate the crosslinking ability of a typical PAE resin with a 1/1 soy flour/urea product (similar to example 1B). Initial soy flour/urea pH levels of 4.5, 7.0 and 10.0 were selected to determine the pH effects on both final performance and neat product characteristics. PAE levels of 0%, 5% and 20% (s/s) were evaluated for stability and performance.

### Example 3

### Addition of PAE Crosslinkers (Low pH)

Preparation Procedure: A product prepared according the procedure in 1B was charged to a three-neck round bottom flask equipped with a mechanical stirrer. The pH was lowered by adding 50% H₂SO₄ at room temperature with stirring. After the acid addition, the solution was stirred for fifteen minutes then stored for use at room temperature.

Example 3A was placed in a beaker and the required amount of PAE was added with stirring. Examples 3B and 3C were prepared using the identical procedure. The samples were vigorously stirred for one minute until homogeneous and then stored for use at room temperature.

TABLE 8
Formula for Example 3A (pH 4.5, 0% PAE)

| Sequence | Ingredient | Amount (g) | Solids | % to Soy/Urea |
|---|---|---|---|---|
| 01 | Like Example 1B | 200.0 | 60.0 | |
| 02 | 50% H₂SO₄ | 2.8 | 1.4 | 2.3 |
| Totals | | 202.8 | 61.4 | |
| % Solids | | | 30.3 | |

TABLE 9
Formula for Example 3B (pH 4.5, 5% PAE)

| Sequence | Ingredient | Amount (g) | Solids | % to Soy/Urea |
|---|---|---|---|---|
| 01 | 3A | 59.8 | 18.1 | |
| 02 | PAE | 4.5 | 0.90 | 5.0 |
| Totals | | 64.3 | 19.0 | |
| % Solids | | | 29.5 | |

TABLE 10
Formula for Example 3C (pH 4.5, 20% PAE)

| Sequence | Ingredient | Amount (g) | Solids | % to Soy/Urea |
|---|---|---|---|---|
| 01 | 3A | 46.2 | 14.0 | |
| 02 | PAE | 14.1 | 2.8 | 20.0 |
| Totals | | 60.3 | 16.8 | |
| % Solids | | | 27.9 | |

### Example 4

### Addition of PAE Crosslinkers (Mid pH)

Examples 4A-C (0%, 5% and 20% PAE) were prepared in an identical procedure as used for Examples 3A-C, albeit with a slightly higher starting pH of the starting product 1B. The pH of Example 4A was lowered to only pH of 7.0 with 50% H₂SO₄.

### Example 5

### Addition of PAE Crosslinkers (High pH)

Examples 5A-C (0%, 5% and 20% PAE) were prepared in an identical procedure as used for examples 3A-C, albeit with a higher starting pH of the starting product 1B. The pH of Example 5A was increased to a pH of 10.0 with the addition of 50% NaOH. The characteristics of the nine products prepared in Examples 3-5 are shown in Table 11.

TABLE 11
Characteristics of Soy/Urea Resins with PAE

| | | Solids | | Brookfield Viscosity | | |
|---|---|---|---|---|---|---|
| Example | Description | Theoretical | Oven | @ 60 RPM | @30 RPM | pH |
| 3A | S/U 1:1 pH 4.5 | 30.3 | 24.2 | 666 | 892 | 4.63 |
| 3B | S/U 1:1 pH 4.5 5% PAE | 29.5 | 25.9 | 368 | 452 | 4.55 |
| 3C | S/U 1:1 pH 4.5 20% PAE | 27.9 | 25 | 330 | 352 | 4.18 |
| 4A | S/U 1:1 pH 7 | 30.1 | 23.7 | 3280 | 4560 | 7.14 |
| 4B | S/U 1:1 pH 7 5% PAE | 29.5 | 26.3 | 5980 | 8820 | 7.28 |
| 4C | S/U 1:1 pH 7 20% PAE | 27.9 | 24.7 | 4270 | 6080 | 7.33 |
| 5A | S/U 1:1 pH 10 | 30.3 | 26.6 | 3620 | 5140 | 10.01 |
| 5B | S/U 1:1 pH 10 5% PAE | 29.5 | 27.4 | 6940 | 10020 | 9.50 |
| 5C | S/U 1:1 pH 10 20% PAE | 27.8 | 26.1 | 4320 | 6080 | 7.00 |

### Performance Evaluation and Discussion

The pH of the final product (after adding PAE) did not deviate too far from the starting pH of the soy flour/urea product, with the exception of the pH 10 products. In this case, the pH was very sensitive to PAE addition. Also, all of the pH 10 products immediately began to slightly off-gas ammonia due to destructive alkaline reactions. As such, the pH of the final composition may be modified after adding the PAE crosslinker.

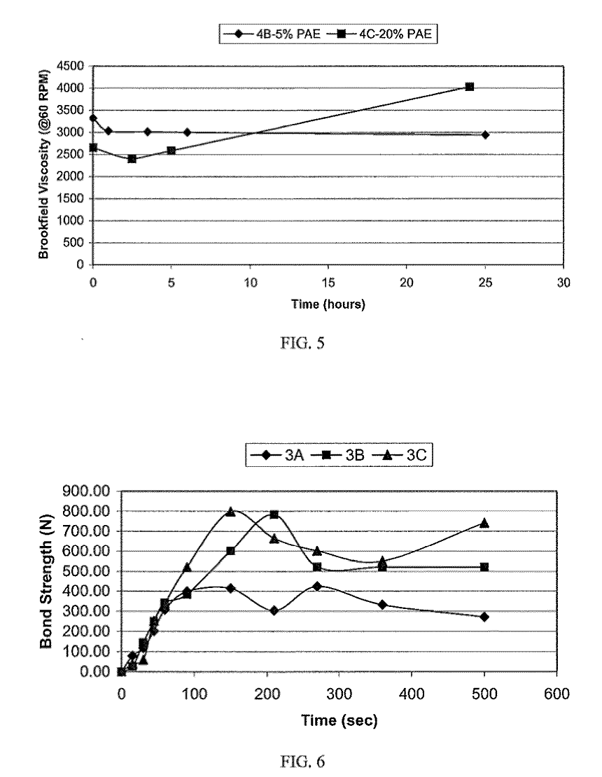

All of the products in Table 11 offer appreciable viscosity stability for at least five hours, with several for greater than twenty hours to more than three days. FIG. 5 depicts the stability of products made according to Examples 4B and 4C. With 5% PAE added (Example 4B) the viscosity was essentially unchanged for more than twenty-four hours; demonstrating a one-component product is achievable. The initial decrease in viscosity observed in both products is due mainly to a foaming phenomenon that can be reduced/removed with the addition of certain anti-foam agents.

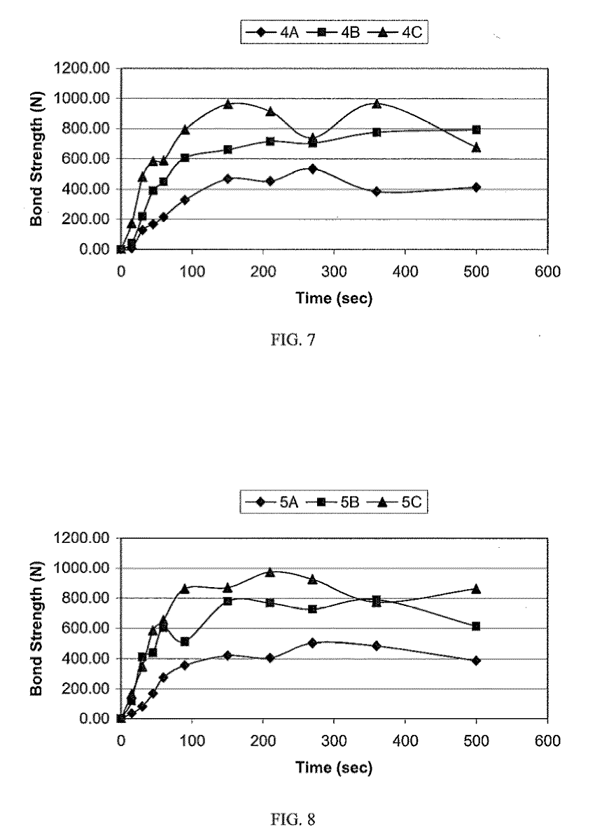

Both the ultimate strength of the product and the rate at which these strengths are developed is of much importance when determining commercial viability of any adhesive candidate. All of the products from Table 11 were evaluated using the Strength Development Procedure outlined earlier in this application. These results are shown in FIGS. 6-9. In all of the cases, there is a clear and consistent increase in the ultimate strength with the addition of the PAE crosslinking agent; although the 5% PAE actually provides a greater increase from 0% than the 20% does from 5%, suggesting that there may be an optimum level of PAE to incorporate into the system.

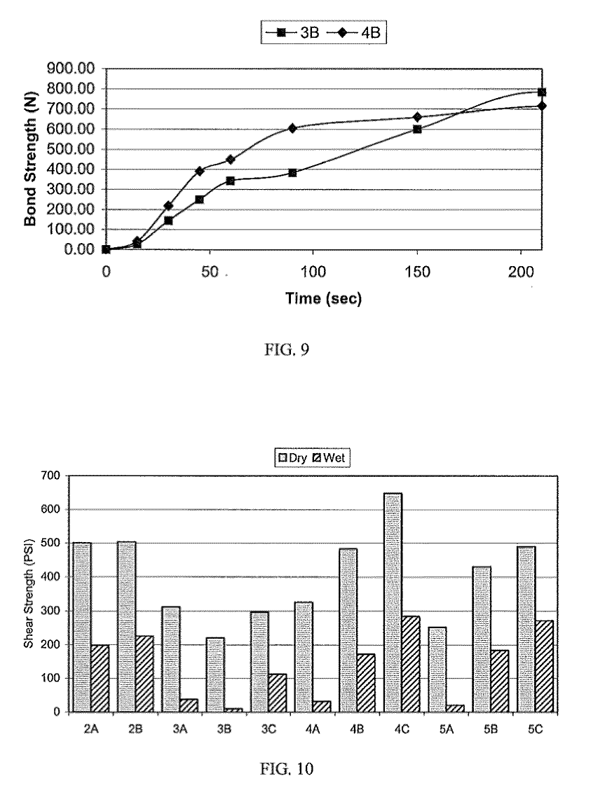

Both the pH 7.0 and the pH 10.0 samples (Example 4 and 5) also demonstrate a greater initial rate for strength development than the control 0% PAE resins; however, this phenomenon was not observed with the pH 4.5 samples, perhaps due to slower PAE reactions under these conditions. Also of interest was the fact that the 5% PAE products (Example 3B) seemed to exhibit a slower curing rate at pH 4.5. This may partially explain the poor wet strength of this specimen relative to the others (see FIG. 9). The HRT developed procedure (HRT ABES/Instron) was used to assess the dry and wet strength of the 9 adhesives in Table 11 (3A-C, 4-A-C and 5A-C) as well as the two comparative examples (Examples 2A-B).

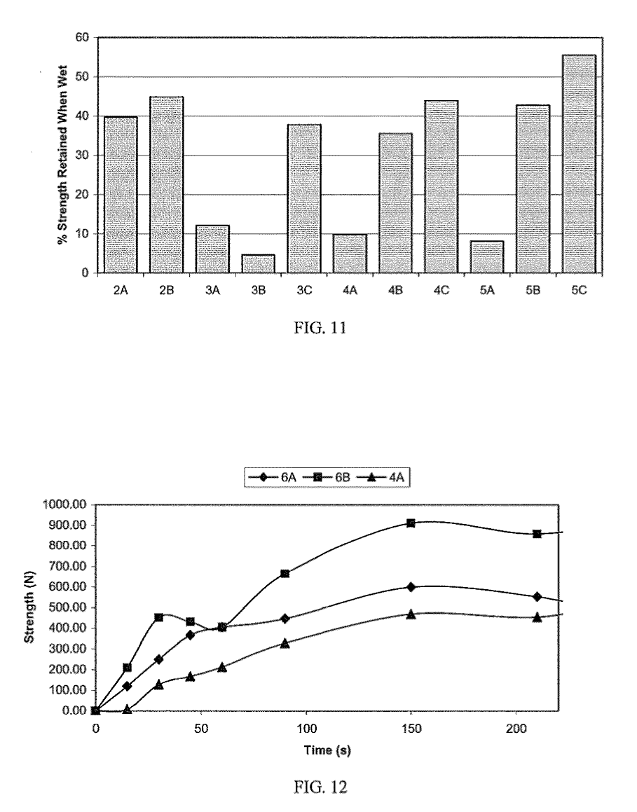

FIG. 10 illustrates the shear strength of the specimens tested dry and wet with the results shown side by side for comparison. FIG. 11 illustrates the percent retention of strength (100×wet/dry). Combined, the comparative SPI products clearly demonstrate the excellent dry and wet strengths capable with these resins without the inclusion of any crosslinking agents. The same cannot be said for the soy flour/urea products that require the addition of a suitable crosslinker to achieve appreciable dry and wet strengths.

However, products made at pH 4.5 do not follow this trend. In fact, the strongest dry strength at pH 4.5 was reported to be the product containing 0% PAE. The wet strength at this pH was improved by adding PAE but not at the levels observed for the higher pH samples. With the exclusion of the pH 4.5 data, adding 5% PAE increases the dry strength by an average of 58% and the wet strength by an average of 572%. Adding 20% PAE to the pH 7.0 and 10.0 products increases the dry strength by 97% and increases the wet strength by an incredible 952%. PAE resins are low pH stable and are base catalyzed self polymerized. It is possible that higher temperatures are needed to complete the cure in these cases due to the low pH.

If one compares Examples 2A and 4A, both composed of approximately 25% protein on a solids basis, the effect of the carbohydrates on the strength properties of flour vs. isolates can be fully appreciated. Adding 5% crosslinker in sample 4B essentially nullifies the effect of the carbohydrates by forming higher MW, less hygroscopic carbohydrate and protein polymers. Thus, crosslinking the carbohydrates is crucial to acquiring the wet strength in the soy flour.

### Example 6

### pMDI Crosslinker

In this example, pMDI is evaluated as a crosslinking agent for the soy flour/urea (1/1) product. Similar to the PAE examples, the effect of the crosslinker concentration was assessed.

In this example, the pH of the starting 1/1 soy/urea product was 7.0 with pMDI levels of 5 and 20%. The process for preparing these products was identical to that used in Example 4.

TABLE 12
Formula for Example 6A (pH 7.0, 5% pMDI)

| Sequence | Ingredient | Amount (g) | Solids | % to Soy/Urea |
|---|---|---|---|---|
| 01 | Like Example 4A | 55.0 | 16.6 | |
| 02 | pMDI | 0.83 | 0.83 | 5.0 |
| Totals | | 55.83 | 17.43 | |
| % Solids | | | 31.2 | |

TABLE 13
Formula for Example 6B (pH 7.0, 20% pMDI)

| Sequence | Ingredient | Amount (g) | Solids | % to Soy/Urea |
|---|---|---|---|---|
| 01 | Like Example 4A | 53.4 | 16.1 | |
| 02 | pMDI | 3.2 | 3.2 | 19.9 |
| Totals | | 56.6 | 19.3 | |
| % Solids | | | 34.1 | |

TABLE 14
Characteristics of Soy Flour/Urea pMDI Resins

| | | Solids | | Brookfield Viscosity | | |
|---|---|---|---|---|---|---|
| Example | Description | Theory | Oven | @ 60 RPM | @30 RPM | pH |
| 6A | S/U 1:1 pH 7, 5% pMDI | 31.2 | 26.9 | 3360 | 4840 | 6.56 |
| 6B | S/U 1:1 pH 7, 20% pMDI | 34.1 | 29.5 | 3840 | 5480 | 6.55 |

### Performance and Discussion

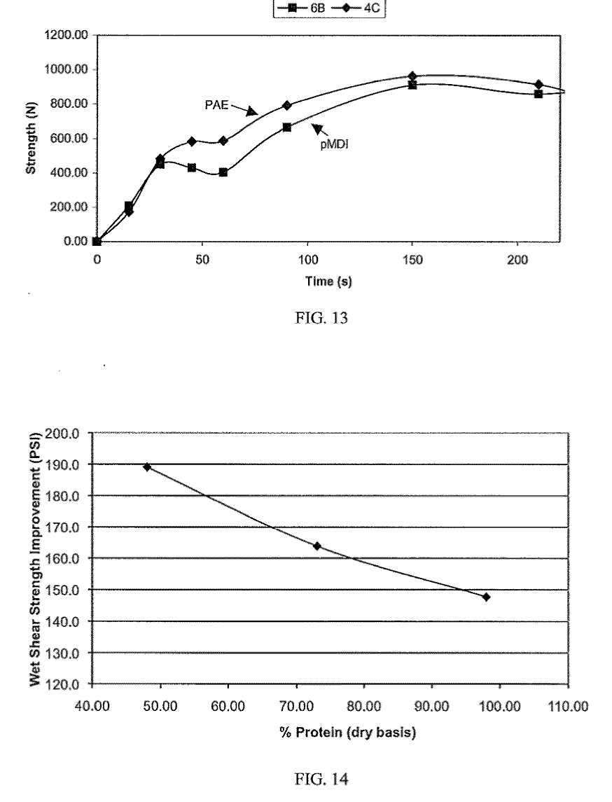

The use of pMDI as a crosslinking agent was evaluated in a manner similar to that of the PAE modified products of Example 4. The characteristics of the soy four/urea/pMDI products are shown in Table 14; strength development curves are shown in FIG. 12. In general, pMDI products are slightly lower in viscosity (even at higher solids) than their PAE modified counterpart. Additionally, the pMDI products are slightly lower in pH. The strength development results show that the dry strengths are increased as a function of pMDI content. Additionally, the rate of strength development is also increased significantly with crosslinker incorporation (similar to that observed with the PAE modified resins). A direct comparison of the PAE vs. pMDI modified products, shown in FIG. 13, illustrates that both products perform comparably in terms of strength and nearly identically with respect to the rate of development. The results of the three-ply soak testing does suggest that urea may be interfering with the pMDI-soy reactions and, thus, it is best to use higher soy/urea ratios when employing pMDI as a crosslinking agent.

### Example 7

### Interior Plywood Qualification

The criteria for interior plywood is the ANSI wet method for delamination. Although a wide range of products are bonded in this market, a large percentage is still prepared from Douglas Fir. In this example, several of the soy/urea adhesives were evaluated along with the adhesives from comparative Example 2. Specimens bonded with the soy flour/urea adhesives were prepared in accordance to the Douglas Fir three-Ply Preparation Procedure outlined above. The specimens bonded with Examples 2A and 2B were prepared differently (per Sun, U.S. Pat. No. 6,497,760); by applying 7.5 g of wet adhesive to one side of each top and bottom ply and to both sides of the center ply. An open time of fifteen minutes was used before the boards were assembled with the grain of the center ply perpendicular to the grain of the top and bottom plys. The assembled three-ply was then pressed for fifteen minutes at 104° C. with a pressure of 11.0 kg/cm². All of the panels were tested according to the ANSI/HPVA HP-1-2004 4.6 “Three-cycle Soak Test” standard. The results are shown in Table 15.

TABLE 15
3-Cycle Soak Results on 3-Ply Douglas Fir Plywood Samples

| Adhesive | Pass/Fail | Comments |
|---|---|---|
| 2A | Passed | Adhesive to both sides with 15 minute open |
| | | time |
| 2B | Passed | Adhesive to both sides with 15 minute open |
| | | time |
| 4B | Failed | Failed after second soak |
| 4C | Passed | |
| 6A | Failed | Failed after first soak |
| 8D | Passed | |

These results demonstrate the ability of soy/urea adhesives when crosslinked with sufficient quantities of crosslinkers to pass the 3-cycle soak test.

### Example 8

### Protein Content Study

In this example, the effect of the protein content on the crosslinking with PAE was evaluated to demonstrate the importance of using a carbohydrate-containing soy product. In this example, three different soy/urea adhesives (having varying protein contents) were prepared in a manner as Example 1C. A soy/urea level of 1:2 was employed for all cases and 5% PAE was used as the crosslinking agent added in a similar manner as described in Example 4B. The characteristics of these adhesives are shown in Table 16. The wet strength of each of these adhesives was assessed using the ABES/Instron procedure outlined previously. The observed wet strength improvement over the non crosslinked resin is presented graphically in FIG. 14 as a function of protein content. Additionally, Example 8D was subjected to soaking conditions outlined in Example 7, and the specimen passed with a minimal amount of PAE (5%).

TABLE 16
Characteristics of Soy/Urea (1/2) with 0% and 5% PAE as a Function of Protein Content

| | | | | | Brookfield Visc (LVT) | | | Shear Strength | | Shear Strength | |
|---|---|---|---|---|---|---|---|---|---|---|---|
| Example | Soy | % Protein | PAE % | (solids) | 60 RPM | 30 RPM | pH | Dry Ave | Wet Ave | Dry Stdev | Wet Stdev |
| 8A | A7B | 48 | 0 | (35.0) | 448 | 636 | 6.98 | 223.9 | 31.6 | 14.0 | 8.7 |
| 8B | A7B | 48 | 5 | (33.7) | 1216 | 1744 | 7.02 | 537.4 | 220.6 | 37.8 | 25.6 |
| 8C | AVF | 73 | 0 | (30.0) | 2680 | 3760 | 7.04 | 332.9 | 83.9 | 43.1 | 17.5 |
| 8D | AVF | 73 | 5 | (29.4) | 1850 | 2680 | 7.03 | 584.5 | 247.7 | 60.6 | 25.6 |
| 8E | SPI | 98 | 0 | (20.0) | 26.5 | 28 | 7.06 | 192.9 | 27.7 | 31.6 | 5.9 |
| 8F | SPI | 98 | 5 | (20.0) | 36 | 40 | 6.98 | 389.7 | 175.5 | 54.8 | 8.1 |
| | PAE Control | 0 | 100 | (20.7) | 113 | 111 | 7.08 | 399.4 | 263.9 | 35.4 | 37.9 |

### Discussion

The results in FIG. 14 clearly demonstrate that not only are the effects of the PAE crosslinking agent not diminished by the presence of the carbohydrates, but in fact, the effects are unexpectedly enhanced. Perhaps a result of the mainly PAE-PAE reactions occurring within these systems as demonstrated by the homo PAE adhesive strengths shown in Table 16. These results clearly show that the carbohydrate fractions are an essential part of the water resistance development that occurs within soy flour adhesives.

### Example 9

### Diluent Effects

It may be desirable to use a non-reactive or reactive diluent to enhance either the wet or dry strength of the product either with or without a crosslinker. The samples were prepared as in Example 3 with a S/U of 0.5 and the exception that glycerol was subsequently added to the mixture at 5, 25 or 100% ratio to the soy in the product. The results of this study are shown in Table 17.

TABLE 17
Addition of Glycerol as a Diluent

| | | | | | Brookfield | | | | | |
|---|---|---|---|---|---|---|---|---|---|---|
| | | | | | Visc LVT | | Sheer Strength | | Sheer Strength | |
| Example | Description | PAE % | Glycerol % | Solids | 30 RPM | pH | Dry Ave | Wet ave | Dry Stdev | Wet Stdev |
| 10A | S/U 1:2 | 10 | 0 | (36.7) | 236 | 5.68 | 810.0 | 247.6 | 202.4 | 73.9 |
| 10B | S/U 1:2 | 10 | 5 | (37.0) | 172 | 5.66 | 1054.2 | 454.6 | 147.0 | 116.9 |
| 10C | S/U 1:2 | 10 | 25 | (38.1) | 244 | 5.8 | 1052.4 | 261.9 | 96.0 | 82.8 |
| 10D | S/U 1:2 | 10 | 100 | (36.7) | 152 | 5.55 | 904.8 | 275.2 | 126.5 | 38.8 |

Discussion—The results from Table 17 show that either the dry or the wet strength can be significantly enhanced by the addition of a diluent. The increase could be attributed to a number of causes, but likely has to do with increased solubility or stabilization of the secondary/tertiary structure that is crucial to soy adhesives for maintaining strength, or from improved wetting of the substrate. Although Example 9 demonstrates the ability to introduce a diluent/modifier post heating, it is acceptable and, perhaps, preferable in certain situations to introduce the diluent/modifer prior to the urease deactivation step.

### Emulsion Control Examples

Commercial polyvinyl acetate (PVAc) was used to compare the effects of adding the soy/urea resins on physical properties and panel performance. Table 18 defines the control samples evaluated.

TABLE 18
Emulsion Control Resins

| Control | % PVA | Comments |
|---|---|---|
| C1 | 100 | Used as received 55.5% solids |
| C2 | 100 | Lower solids to match solids content of soy/urea |
| | | modified resins |
| C3 | 75 | Addition of 25% of a 37% urea solution |

In Examples 10-20, soy flour was heat denatured and then reacted with urea to produce stable soy/urea aqueous resins. The process may either be a one-stage or a two-stage process.

### Example 10

### Soy/Urea Adhesive for Use with Polymer Dispersion (1 Stage Approach)

In the first example, a one-stage process was employed using the formula shown in Table 19.

TABLE 19
Formula for Example 10.

| Sequence | Ingredient | Amount (g) | Solids | Soy/Urea |
|---|---|---|---|---|
| 01 | Water | 192.0 | 0 | |
| 02 | Urea | 57.2 | 57.2 | 1.0 |
| 03 | Soy Flour-A7B | 60.0 | 57.2 | 1.0 |
| Totals | | 309.2 | 114.4 | |
| % Solids | | | 37.0 | |

Preparation Procedure: Water was charged into a three-neck round bottom flask equipped with a heating mantle, temperature controller, reflux condenser and mechanical stirrer. Urea was added to the water at room temperature and stirred over a period of two to five minutes until completely dissolved. Soy flour (A7B) was then charged over five minutes, at room temperature, to the rapidly stirring solution. The mixture was stirred for five minutes to homogeneity and then heated to 90° C. over 15-30 minutes. The reaction was held at 90±2° C. for one hour with stirring. The reaction was cooled to 25° C. on ice/water bath and stored for use in plastic bottles at room temperature.

### Example 11

### Say/Urea Adhesives for Use with Polymer Dispersions (2 Stage Approach)

This example demonstrates the two-stage process to use with high urease soy flours are used.

TABLE 20
Formula for Example 11

| Sequence | Ingredient | Amount (g) | Solids | % to Soy |
|---|---|---|---|---|
| 01 | Water | 703.0 | 0 | |
| 02 | Soy Flour-A7B | 160.0 | 152.5 | 1.0 |
| 03 | Urea | 152.5 | 152.5 | 1.0 |
| Totals | | 1015.5 | 305.0 | |
| % Solids | | | 30.0 | |

Preparation Procedure: Water was charged into a three-neck round bottom flask equipped with a heating mantle, temperature controller, reflux condenser and mechanical stirrer. The soy flour (A7B) was added to the water at room temperature over a period of 2-5 minutes. The mixture was stirred for 5 minutes to homogeneity and then heated to 90° C. over 15-30 minutes. The reaction was held at 90±2° C. for 1 hour with stirring at which time the urea was added and the reaction was reheated to 90° C. and held at 90±2° C. with stirring for 1 hour. The reaction was cooled to 25° C. on ice/water bath and stored for use in plastic bottles at room temperature.

### Examples 12-18

### More Soy/Urea Adhesive and Addition to PVAc

Examples 12-18 follow either the one-stage or the two-stage processes outlined above in Examples 10 and 11, respectively. Variations demonstrated are soy/urea ratio and reaction temperature. See Table 21 for the detailed characteristics of these resins.

Soy/Urea/PVAc Examples: To assess the ability of the soy/urea adhesives to function as co-adhesives or extenders with polyvinyl acetate (PVAc), several soy/urea/PVAc adhesive combinations were prepared using the following procedure.

Preparation Procedure: PVAc was charged into a three-neck round bottom flask equipped with a mechanical stirrer and thermometer. The temperature was adjusted to 22-24° C. using water baths. The soy/urea co-adhesive (selected from Examples 10-18) was added to the rapidly stirring PVAc emulsion at room temperature over a period of 2-5 minutes. The mixture was stirred for 15 minutes to ensure homogeneity. The pH of the mixture was measured and reported as “pH Initial”. Sulfuric acid (50%) was then added drop-wise to lower the pH to a final value of 4.4-4.6. The amount of acid required to reduce the pH was reported as concentrated sulfuric acid to solution basis. These PVAc/Soy/Urea adhesives were allowed to stir for an additional 15 minutes and then were stored for use in plastic bottles at room temperature.

PVA/Soy/Urea Nomenclature: For all examples in this patent containing PVAc, the following identification method is used: If a PVAc/Soy/Urea emulsion is prepared using the soy/urea prepared in example 1 and contains 75% PVAc (solids basis), the sample will be labeled Example 1-75. Thus Example 6-50 is a 50% PVAc 50% Soy/Urea combination (solids basis) prepared from the Example 6 soy/urea base. A compilation of these examples, along with all of their physical characteristics can be found in Table 4.

For the purposes of the charts the following is used: #stages-flour type-denature temp-soy/urea ratio-% copolymer 2A90-1-75=2 Stage process, A7B flour, 90 C temperature, Soy/urea=1/1, combined with 75 parts of PVAc on a solids basis.

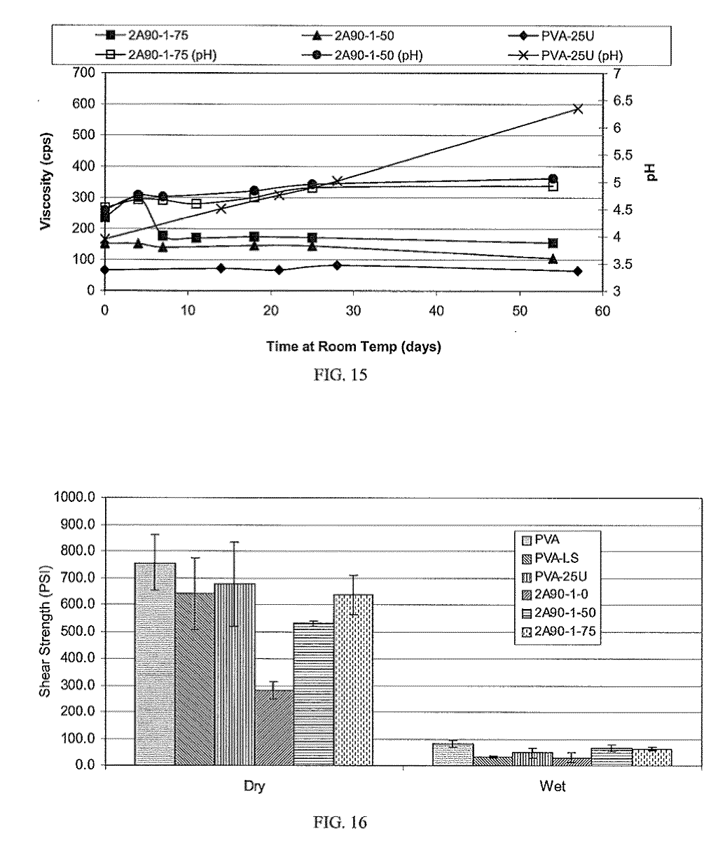

Discussion. The excellent stabilities demonstrated for the soy/urea are also observed with the soy/urea/PVAc resins (FIG. 15). Notably, the pH stability of the soy/urea/PVAc is much greater than that of the urea/PVAc control resin (Example C3). Further, the shear thinning behavior of the soy/urea is decreased and often times no longer observed at all in the soy/urea/PVAc resins.

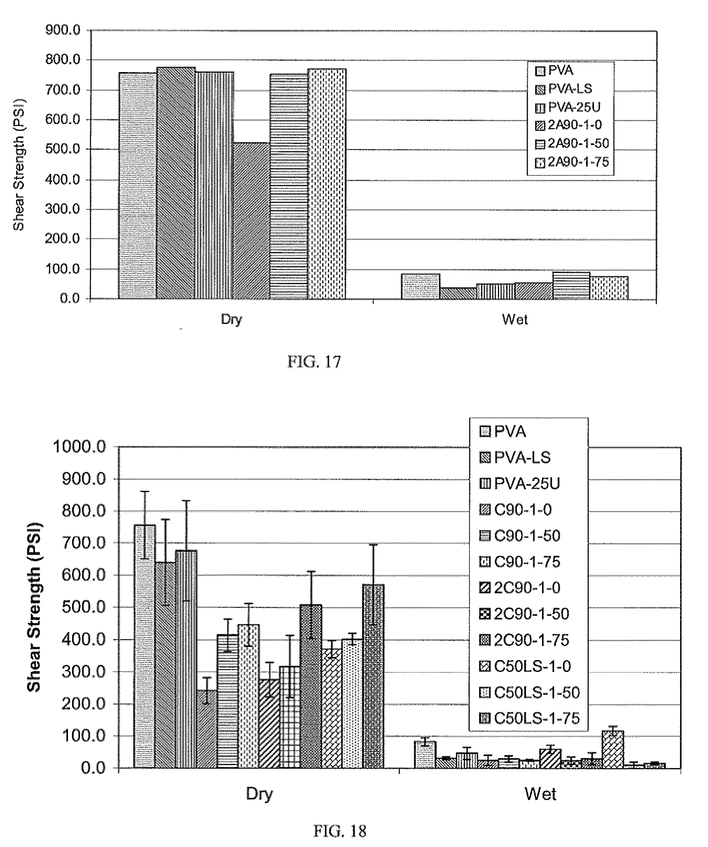

Performance Evaluation (ABES/Instron Method). PVAc is not well known for its wet strength in typical PVAc formulations. As shown in FIG. 16, the soy/urea resin is also not well suited for wet applications without the addition of a reactive crosslinking agent. However, 25-50% of the PVAc can be replaced with soy/urea with minimal loss in dry strength even with lower percent solids. FIG. 17 shows a percent solids normalized chart of FIG. 16, illustrating that there is no discernable decrease in dry or wet strength with even up to 50% Soy/Urea. Thus, the soy/urea adhesive when combined with PVAc at 50% level is equal in strength on a solids basis with PVAc. It should be noted that 50% urea modified PVAc samples were prepared, but no samples could be prepared using a hot pressing procedure (120° C.) as they all blew up coming out of the press. This is believed to be a result of the lowering of the Tₛ with the plasticizing urea. The T_{g} of soy is much higher and, thus, this was not an issue with the soy/urea resins.

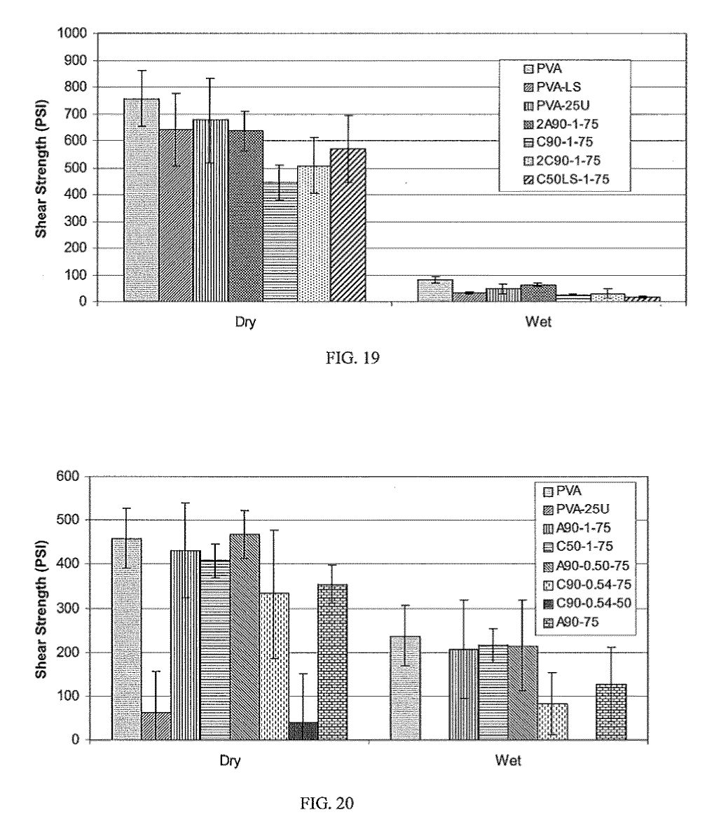

Using low-urease soy (CG4) can enable a simple, one-stage approach. FIGS. 18 and 19 demonstrate the effect of temperature and stages (one vs. two) on the soy/urea product. The results suggest that the toasted soy in all examples is slightly weaker in strength than the untoasted soy with higher PDI demonstrated above.

Within the toasted soy set itself, the lower temperature resins showed greater strengths, most notably showing a much improved wet strength (Example 15). This is also shown in the surprising wet strength of the three-ply samples using a low temperature, one-stage approach on the toasted flour.

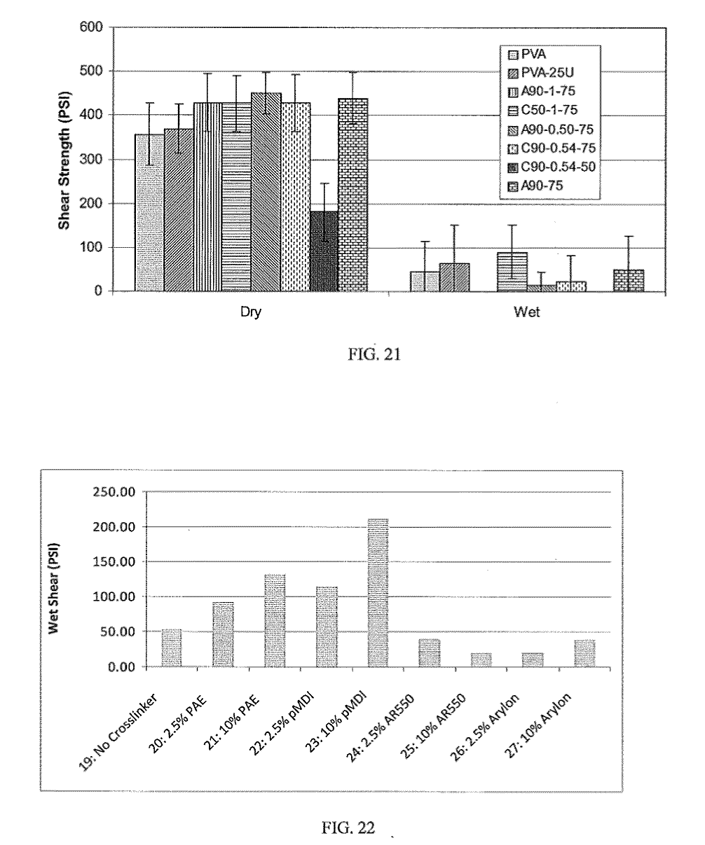

Evaluation Method (Maple 3-Ply). Shear blocks were prepared from 3-ply maple assemblies that were pressed under both room temperature (45 minute) conditions and 150° C. (5 min) conditions. These results are graphically shown in FIGS. 20 and 21 and tabulated in Table 23 attached. As expected, since the samples are much larger than those prepared on the ABES, the T_{g} depression as observed with urea addition is exacerbated to a point that even the 25% urea containing samples show some delamination immediately out of the hot press. These urea-modified samples do not possess enough strength while hot due to their low T_{g}. In general, this was not a problem with the soy/urea samples except with the 50% modified PVAc, but in this example the soy/urea level was a very low 0.54, thus the amount of urea was simply too great and again T_{g} depression was likely the problem.

The cold pressed samples all demonstrate the ability of the soy/urea/PVAc resins with 25% PVAc substitution (75% PVAc) to perform comparably in most of the samples. Surprisingly, in this study, the 50% PVAc sample performed poorly, perhaps a result of the lower solids of this adhesive. Wood failures for all of these resins ranged from 0-60% within the entire data set with no obvious trending.

TABLE 21
Characteristics of Soy/Urea/PVAc Resins

| | | | | | | | | | | | Viscosity | |
|---|---|---|---|---|---|---|---|---|---|---|---|---|
| | | Soy | | S/U | | % | Theor. | | | | LVT @ | LVT @ |
| Ex. # | Desc. | Type | T (C) | (s/s) | Stgs | PVA | Solids | pH Ini | % Acid | pH F | >60 RPM | 30 RPM |
| C1 | PVA | | | | | 100 | | | | | | |
| C2 | PVA-LS | | | | | 100 | 45.8 | 4.06 | | | 320 | 328 |
| | 37U | | | | | 0 | 37.0 | | | 6.21 | | |
| C3 | PVA-25U | | | | | 75 | 49.4 | 3.95 | 0.00 | 3.95 | 66.5 | 64 |
| C4 | PVA-50U | | | | | 50 | 44.4 | 4.35 | 0.00 | 4.35 | NOT MEASURED | |
| 10 | A90-1-0 | A7B | 90 | 1.00 | 1 | 0 | 37.0 | | | 10.13 | 4050 | 5900 |
| 10-75 | A90-1-75 | | | | | 75 | 49.3 | 9.83 | 2.53 | 4.30 | 1102 | 1308 |
| 11 | 2A90-1-0 | A7B | 90 | 1.00 | 2 | 0 | 30.0 | | | 7.77 | 2590 | 3600 |
| 11-75 | 2A90-1-75 | | | | | 75 | 45.8 | 6.63 | 0.53 | 4.53 | 236 | 284 |
| 11-50 | 2A90-1-50 | | | | | 50 | 38.9 | 7.32 | 0.91 | 4.48 | 152 | 152 |
| 12 | C90-1-0 | CG4 | 90 | 1.00 | 1 | 0 | 30.0 | | | 8.21 | 2970 | 4260 |
| 12-75 | C90-1-75 | | | | | 75 | 45.8 | 7.05 | 0.61 | 4.52 | 274 | 316 |
| 12-50 | C90-1-50 | | | | | 50 | 38.9 | 7.79 | 1.01 | 4.49 | 260 | 334 |
| 13 | 2C90-1-0 | CG4 | 90 | 1.00 | 2 | 0 | 30.0 | | | 7.79 | 4600 | 6980 |
| 13-75 | 2C90-1-75 | | | | | 75 | 45.8 | 6.80 | 0.58 | 4.49 | 278 | 310 |
| 13-50 | 2C90-1-50 | | | | | 50 | 38.9 | 7.44 | 1.01 | 4.49 | 252 | 327 |
| 14 | C50-1-0 | CG4 | 50 | 1.00 | 1 | 0 | 37.0 | | | 6.91 | OFF | OFF |
| 14-75 | C50-1-75 | | | | | 75 | 49.3 | 6.06 | 0.50 | 4.44 | 498 | 508 |
| 15 | C50LS-1-0 | | | | | 0 | 30.0 | | | 6.75 | 894 | 1268 |
| 15-75 | C50LS-1-75 | | | | | 75 | 45.8 | 5.91 | 0.40 | 4.51 | 148 | 152 |
| 15-50 | C50LS-1-50 | | | | | 50 | 38.9 | 6.43 | 0.73 | 4.49 | 86 | 91 |
| 16 | A90-.050-0 | A7B | 90 | 0.50 | 1 | 0 | 37.0 | | | 9.76 | 251 | 336 |
| 16-75 | A90-0.50-75 | | | | | 75 | 49.3 | 9.41 | 1.80 | 3.68 | 466 | 532 |
| 17 | C90-0.54-0 | CG4 | 90 | 0.54 | 1 | 0 | 43.2 | | | 9.19 | 3280 | 4800 |
| 17-75 | C90-0.54-75 | | | | | 75 | 51.8 | 7.30 | 0.66 | 4.35 | 448 | 468 |
| 17-50 | C90-0.54-50 | | | | | 50 | 48.6 | 8.25 | 1.10 | 4.48 | 604 | 696 |
| 18 | A90-0 | A7B | 90 | no urea | 1 | 0 | 15.0 | | | 6.80 | 538 | 764 |
| 18-75 | A90-75 | | | | | 75 | 33.1 | 6.23 | 0.51 | 4.49 | 422 | 480 |

(PVA = PVAc in these tables)

TABLE 22
Shear Strength Evaluation of Soy/Urea/PVAc
Resins (ABES/Instron)

| | | ABES/Instron | | | |
|---|---|---|---|---|---|
| | | Dry | | Wet | |
| | | Strength | | Strength | |
| Example | Desc. | (PSI) | StDev | (PSI) | StDev |
| C1 | PVA | 756.1 | 105.0 | 82.6 | 12.8 |
| C2 | PVA-LS | 640.1 | 133.7 | 31.6 | 4.8 |
| | 37U | | | | |
| C3 | PVA-25U | 676.2 | 156.2 | 47.1 | 19.0 |
| C4 | PVA-50U | Delam | NA | Delam | NA |
| 10 | A90-1-0 | | | | |
| 10-75 | A90-1-75 | | | | |
| 11 | 2A90-1-0 | 283.4 | 32.5 | 29.5 | 17.7 |
| 11-75 | 2A90-1-75 | 638.2 | 73.2 | 62.7 | 6.1 |
| 11-50 | 2A90-1-50 | 528.7 | 8.3 | 64.5 | 11.6 |
| 12 | C90-1-0 | 242.1 | 40.6 | 25.2 | 15.9 |
| 12-75 | C90-1-75 | 446.3 | 65.9 | 25.2 | 2.7 |
| 12-50 | C90-1-50 | 414.1 | 50.0 | 29.7 | 9.8 |
| 13 | 2C90-1-0 | 276.3 | 53.4 | 60.0 | 13.0 |
| 13-75 | 2C90-1-75 | 508.1 | 103.7 | 30.3 | 185 |
| 13-50 | 2C90-1-50 | 317.5 | 96.5 | 24.5 | 11.3 |
| 14 | C50-1-0 | | | | |
| 14-75 | C50-1-75 | | | | |
| 15 | C50LS-1-0 | 371.6 | 26.2 | 116.8 | 14.3 |
| 15-75 | C50LS-1-75 | 571.2 | 124.5 | 16.1 | 4.0 |
| 15-50 | C50LS-1-50 | 402.5 | 17.0 | 10.3 | 10.0 |

TABLE 23
Shear Strength Evaluation of Soy/Urea/PVAc Resins (Maple 3-Ply)

| | | 3-PLY-5 min @ 150 C. | | | | 3-PLY-45 min @ 23 C. | | | |
|---|---|---|---|---|---|---|---|---|---|
| | | Dry | | Wet | | Dry | | Wet | |
| | | Strength | | Strength | | Strength | | Strength | |
| Example | Desc. | (PSI) | StDev | (PSI) | StDev | (PSI) | StDev | (PSI) | StDev |
| C1 | PVA | 458.8 | 68.9 | 237.5 | 69.3 | 357.1 | 70.7 | 45.5 | 70.1 |
| C3 | PVA-25U | 61.8 | 94.8 | 0.0 | 0.0 | 368.8 | 56.3 | 65.3 | 87.5 |
| 10-75 | A90-1-75 | 431.6 | 107.5 | 206.9 | 111.6 | 429.1 | 66.8 | 0.0 | 0.0 |
| 14-75 | C50-1-75 | 407.5 | 38.3 | 216.0 | 38.7 | 427.3 | 64.4 | 90.4 | 60.3 |
| 16-75 | A90-0.50-75 | 467.4 | 54.2 | 214.8 | 103.1 | 450.9 | 48.3 | 15.4 | 30.1 |
| 17-75 | C90-0.54-75 | 333.3 | 145.5 | 83.1 | 70.4 | 428.5 | 64.3 | 21.6 | 61.2 |
| 17-50 | C90-0.54-50 | 39.5 | 111.7 | 0.0 | 0.0 | 180.7 | 65.0 | 0.0 | 0.0 |
| 18-75 | A90-75 | 353.8 | 43.5 | 127.0 | 85.7 | 438.6 | 58.9 | 49.5 | 77.9 |

### Examples 19-27

### Soy/Urea Adhesives with PVAc and Crosslinkers

Soy/urea/PVAc 25/75° with added crosslinking agent. By adding the soy/urea adhesive to the PVAc emulsion, functionality has been introduced to the resin chemistry. This added functionality can be used to introduce improved water resistance to PVAc resins by adding a reactive crosslinking agent capable of reacting with the soy, the PVAc or both. Four different reactive crosslinkers were added to the system at levels of 2.5 and 10% to soy/urea to assess their potential to impart wet strength to these stable, compatible emulsions.

Preparation Procedure: The soy/urea/PVAc uncrosslinked base resin was prepared identical to Example 11-50 of Table 21. The reactive crosslinking agents were added to the resin with rapid stirring. The types and amounts added are as shown in Table 24.

TABLE 24
Crosslinking Agents Added to SUP with PVAc

| Example | Crosslinker | |
|---|---|---|
| 19 | None | |
| 20 | 2.5% | PAE |
| 21 | 10.0% | PAE |
| 22 | 2.5% | pMDI |
| 23 | 10.0% | pMDI |
| 24 | 2.5% | AR550 |
| 25 | 10.0% | AR550 |
| 26 | 2.5% | Arlon |
| 27 | 10.0% | Arlon |

Discussion (Evaluation Method—ABES/Instron): Adding reactive crosslinkers improved the wet strength of the PVAc-modified adhesives. For instance, adding AR550 and the Arlon showed no additional wet strength in the resins (FIG. 22). Most notable, the excellent performance improvement observed by the addition of the pMDI.

### Example 28

### SUP with PF Dispersion

Soy/Urea/PF dispersion: In addition to adding the soy/urea co-adhesive to PVAc, it was also evaluated with a phenol formaldehyde (PF) dispersion.

TABLE 25
Formula for Example 28

| Sequence | Ingredient | Amount (g) | Solids | % of Solids |
|---|---|---|---|---|
| 01 | PF Resin | 50.0 | 24.5 | 48 |
| 02 | Soy/Urea (Ex. 11) | 87.1 | 26.1 | 52 |
| 03 | Sulfonyl 420 | 0.5 | 0.5 | |
| 04 | H₂SO₄ | 3.1 | 1.55 | |
| Totals | | 140.7 | 52.6 | |
| % Solids | | | 37.4 | |

Preparation Procedure: A Soy/Urea/PF dispersion was prepared at room temperature in a 250 mL round bottom flask equipped only with an overhead stirrer. The PF resin (lab prepared F/P=2.1, Na/P=0.2) was charged to the flask along with the surfactant, all at room temperature. After stirring for 2-3 minutes, 2.2 g H₂SO₄ was charged to the rapidly stirring PF solution. The PF resin inverted to a low viscosity, white dispersion. The soy/urea resin from Example 11 was then charged over 5 minutes to the rapidly stirring dispersion and allowed to stir for an additional 5 minutes. The pH was then adjusted using 0.9 g of 50% H₂SO₄. The soy/urea/PF dispersion was then allowed to stir for 10 minutes. A stable low viscosity product was observed. The characteristics of this resin are shown along with the shear strength analysis in Table 26.

TABLE 26
Soy/Urea/PF Dispersion Characteristics and Shear Strength Analysis (ABES/Instron)

| | | | | | | Viscosity | | Dry | Wet |
|---|---|---|---|---|---|---|---|---|---|
| | | | | Theor. | | LVT @ | LVT @ | Strength | Strength |
| Example | Desc. | Copoly | % S/U | Solids | pH F | 60 RPM | 30 RPM | (PSI) | (PSI) |
| C2 | PVA-LS | PVA | 0 | 45.8 | | 320 | 328 | 640 (134) | 32 (5) |
| 11 | 2A90-1-0 | None | 100 | 30.0 | 7.77 | 2590 | 3600 | 283 (33) | 29 (18) |
| 28 | 2A90-1-48PF | PF | 52 | 37.3 | 7.43 | 145 | 150 | 447 (45) | 151 (26) |
| 28-150 C | 2A90-1-48PF | PF | 52 | 37.3 | 7.4 | 145 | 150 | 622 (122) | 454 (9) |

( ) denotes standard deviation

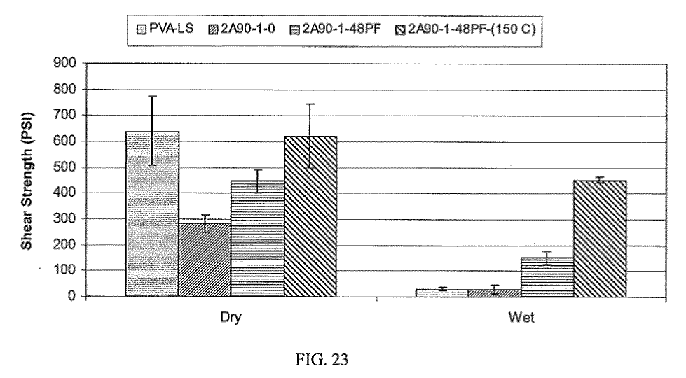

Discussion (Evaluation Method—ABES/Instron): The wet strength of the soy/urea resin is greatly improved by adding the dispersion PF resin that also serves as a viable crosslinker. The resin is light in color, low in viscosity, and void of the thixotropic nature typically observed in soy resins. The results in FIG. 23 clearly show the excellent wet strength obtained for such a high soy modified product, especially at the higher 150° C. press temperature. This example demonstrates that it is possible and practical to combine the soy/urea with a PF dispersion and achieve a high level of water resistance.

### Example 29—Comparative Example

### High Temperature Caustic Denaturing

This example demonstrates the inability to use the high temperature, caustic denaturing process as described by Wescott (U.S. Pat. No. 7,345,136) for the production of the soy/urea product.

TABLE 27
Formula for Example 29

| Sequence | Ingredient | Amount (g) | Solids | % to Soy |
|---|---|---|---|---|
| 01 | Water | 312.01 | | |
| 02 | Ethylene Glycol | 2.75 | 2.75 | |
| 03 | NaOH | 15.0 | 15.0 | 11.1 |
| 04 | Soy Flour-A7B | 142.21 | 135.1 | |
| 05 | Urea | 142.21 | 142.2 | 105 |
| Total | | 614.18 | 295.0 | |

Preparation Procedure—To a 3-neck, 2 L round bottom flask, equipped with an overhead stirrer, and condenser, water was charged, followed by ethylene glycol and then NaOH pellets. After the dissolution of the NaOH, the alkaline mixture was heated to 88-92° C. over 45 minutes. The soy flour was then added over 10 minutes, slowly to the rapidly stirring solution and held for an additional 1 hr at 88-92° C. After the hold period, the heat was removed and the urea was added rapidly to the stirring denatured soy flour. An immediate strong ammonia smell was noticed. The odor was very strong and burned the eyes. The final product was allowed to stir for 15 minutes, then cooled to room temperature and evaluated for physical properties. Theoretical solids: 48%, pH=12.74, Viscosity 615 cP.

### Example 30—Comparative Example

### Direct Addition of Formaldehyde

This example demonstrates the inability to produce a methylolated protein by the direct addition of formaldehyde to the denatured soy produced by the method described in this application. The soy denaturing process is the same as that used in many of the examples shown above.

TABLE 28
Formula for Example 30

| Sequence | Ingredient | Amount (g) | Solids | % to Soy |
|---|---|---|---|---|
| 01 | Water | 225.3 | | |
| 02 | Soy Flour-TS | 94.73 | 90 | |
| 03 | CH2O (37%) | 3.6 | 1.3 | 1.5 |
| Total | | | | |

Preparation Procedure—To a 3-neck, 2 L round bottom flask, equipped with an overhead stirrer, and condenser, water was charged, followed by the soy flour. The mixture was then heated to 81° C. over 25 minutes and held for an additional 1 hr at 81-83° C. After the hold period, the formaldehyde was added drop-wise to attempt to produce the methyolated. However, after only a few drops of formadehyde had been added, the entire mixture became a solid gelled resin that could no longer be stirred. This exemplifies the need for more aggressive denaturing to produce a mentholated protein. Thus, the process described in this application is not suitable to produce an adhesive similar to that taught by Wescott (U.S. Pat. No. 7,345,136).

It should be noted that the above description, attached figures and their descriptions are intended to be illustrative and not limiting of this invention. Many themes and variations of this invention will be suggested to one skilled in this and, in light of the disclosure. All such themes and variations are within the contemplation hereof. For instance, while this invention has been described in conjunction with the various exemplary embodiments outlined above, various alternatives, modifications, variations, improvements, and/or substantial equivalents, whether known or that are or may be presently unforeseen, may become apparent to those having at least ordinary skill in the art. Various changes may be made without departing from the spirit and scope of the invention. Therefore, the invention is intended to embrace all known or later-developed alternatives, modifications, variations, improvements, and/or substantial equivalents of these exemplary embodiments.

We claim:

1. A method for making a stable adhesive, the method comprising:
heating soy flour to a temperature of at least 81° C. until denatured and substantially free of urease; and
adding urea to the soy flour, wherein a stable, soy/urea adhesive is formed.

2. The method of claim 1 wherein the soy flour is heated to a temperature of from 81° C. to 100° C. for a period of at least 15 to 500 minutes.

3. The method of claim 1 wherein the urea is added to the soy flour after the soy flour is substantially free of urease.

4. The method of claim 1 wherein the urea is added to the soy flour before the soy flour is substantially free of urease.

5. The method of claim 1 wherein the urea is added to the substantially urease-free soy flour in an amount equivalent to at most five parts urea for every one part soy flour.

6. The method of claim 1 further comprising adding a crosslinking agent to the soy/urea adhesive.

7. The method of claim 6 wherein the crosslinking agent is a formaldehyde-free crosslinking agent selected from the group consisting of isocyanate, polyamine epichlorohydrin resin, polyamidoamine-epichlorohydrin resin, polyalkylene polyamine-epichlorohydrin, amine polymer-epichlorohydrin resin epoxy, aldehyde, aldehyde starch, dialdehyde starch, glyoxal, urea glyoxal, urea-aldehyde resin and mixtures thereof.

8. The method of claim 1 further comprising the step of drying the soy/urea adhesive to produce a powder adhesive.

9. The method of claim 6 wherein the crosslinking agent is a formaldehyde-containing crosslinking agent selected from the group consisting of formaldehyde, phenol formaldehyde, melamine formaldehyde, urea formaldehyde, melamine urea formaldehyde, phenol resorcinol and any combination thereof.

10. The method of claim 1 further comprising adding a diluent to the soy/urea adhesive.

11. The method of claim 10 wherein the diluent is selected from the group consisting of glycerol, ethylene glycol, propylene glycol, neopentyl glycol and polymeric versions thereof.

12. A method for making a stable soy/urea dispersion, the method comprising:
heating soy flour to a temperature of at least 81° C. until denatured and substantially free of urease;
adding urea to the soy flour to form a soy/urea adhesive; and
adding a polymer to the soy/urea adhesive, wherein a stable soy/urea dispersion is formed.

13. The method of claim 12 wherein the polymer is an emulsified or dispersed polymer.

14. The method of claim 12 wherein the polymer is polyvinyl acetate (PVAc) or phenol formaldehyde.

15. The method of claim 12 wherein the soy flour is heated to a temperature of from 81° C. to 100° C. for at least 15 to 500 minutes.

16. The method of claim 12 wherein the urea is added to the soy flour in an amount equivalent to at most five parts and at least 0.25 parts urea for every one part soy flour.

17. The method of claim 12 further comprising adding a crosslinking agent to the soy/urea dispersion.

18. The method of claim 17 wherein the crosslinking agent is a formaldehyde-free crosslinking agent selected from the group consisting of polymeric methyl diphenyl diisocyanate, polyamine epichlorohydrin, epoxy and glyoxal.

19. The method of claim 17 wherein the crosslinking agent is added in an amount between 0.1 and eighty percent by weight.

20. The method of claim 17 wherein the crosslinking agent is a formaldehyde-containing crosslinking agent selected from the group consisting of formaldehyde, phenol formaldehyde, melamine formaldehyde, urea formaldehyde, melamine urea formaldehyde, phenol resorcinol and any combination thereof.
